(19) United States
(12) Patent Application Publication
(10) Pub. No.: US 2026/0005445 A1
(43) Pub. Date: Jan. 1, 2026

(54) REFLECTOR ARRAY, REFLECTOR ARRAY DEVICE, AND METHOD FOR DESIGNING A REFLECTOR ARRAY

(71) Applicant: TOPPAN HOLDINGS INC., Tokyo (JP)

(72) Inventors: Jumpei IMAI, Tokyo (JP); Hiroyoshi Nishiyama, Tokyo (JP); Shinpei Kondo, Tokyo (JP); Daiki Nishimura, Tokyo (JP)

(73) Assignee: TOPPAN HOLDINGS INC., Tokyo (JP)

(21) Appl. No.: 19/314,455

(22) Filed: Aug. 29, 2025

Related U.S. Application Data
(63) Continuation of application No. PCT/JP2023/037322, filed on Oct. 16, 2023.

(30) Foreign Application Priority Data
Mar. 3, 2023 (JP) 2023-032783

(51) Int. Cl. H01Q 15/16; H01Q 15/14

(52) U.S. Cl. CPC H01Q 15/167; H01Q 15/147

(57) ABSTRACT

The present invention aims to provide a technique for improving a non-defective product rate. One of typical reflectarrays of the present invention is a reflectarray including at least a layer of element patterns, a dielectric layer, and a ground layer laminated in this order, wherein the reflectarray includes at least one reflection control areal; the reflection control area includes at least two unit cells; one element pattern is arranged on each unit cell; the element pattern includes a cross-patch in which two rectangular patches are orthogonal to each other in an xy plane; and in the reflection control area, a first element width wx which is a width of the element pattern in an x axis direction or/and a second element width wy which is a width of the element pattern in a y axis direction is/are different between the element patterns arranged in the respective at least two unit cells.

### CROSS-REFERENCE TO RELATED PATENT APPLICATIONS

The present application is a Bypass Continuation of International Patent Application No. PCT/JP2023/037322, filed Oct. 16, 2023, which claims priority to and the benefit of Japanese Patent Application No. 2023-032783, filed on Mar. 3, 2023. The contents of these applications are hereby incorporated by reference herein in their entireties.

### TECHNICAL FIELD

The present invention relates to reflectarrays, reflectarray devices, and methods of designing a reflectarray.

### BACKGROUND

With the advancement of digitalization in society, data communication speeds in wireless communication have increased significantly, and this has led to use of higher frequencies of electromagnetic waves. However, as the frequencies of electromagnetic waves increase, they tend to travel with accordingly increased linearity, which means that electromagnetic waves cannot reach areas such as the shadows of buildings, resulting in creating dead zones where communication is not possible.

For these reasons, in order to realize 5G or 6G communications over a wide area, the number of base stations needs to be increased. However, increasing the number of base stations requires huge costs, and therefore quick increase of the number of base stations is difficult. In recent years, to solve these issues, techniques for controlling the direction of electromagnetic waves have been attracting attention.

With these techniques, reflectors using cruciform reflecting elements have been developed. PTL 1 discloses the following technique.

A metasurface reflector includes a dielectric substrate, a metal ground layer provided on the bottom surface of the dielectric substrate to prevent polarized waves of all directions from passing through the metasurface reflector, and multiple supercells having two or more types of cruciform metal resonators with different arm lengths. These supercells with metal resonators are formed on the top surface of the dielectric substrate and arrayed with a periodicity of a diffraction grating that reflects vertically and horizontally polarized incident waves and anomalously reflects electromagnetic waves of a predetermined frequency at the required phase.

PTL 2 discloses the following technique.

A reflectarray, in which a plurality of reflective elements are arranged on a substrate, reflects first polarized waves having an electric field component parallel to the surface of the substrate and second polarized waves having an electric field component perpendicular to the surface in first and second desired directions. In the reflectarray, the plurality of reflective elements have respective patches spaced apart from a ground plate, with each gap between the patches of adjacent reflective elements in a first axial direction being set to a value suitable for the location of the gap so that the first polarized waves are reflected at a predetermined reflection phase, and with each gap between the patches of adjacent reflective elements in a second axial direction perpendicular to the first axial direction being set to a value suitable for the location of the gap so that the second polarized waves are reflected at a predetermined reflection phase.
[Citation List][Patent Literature] PTL 1: JP2021-48465A PTL 2: JP5469724B

### SUMMARY OF THE INVENTION

### Technical Problem

In the reflectarray having element patterns including cruciform patterns, if a dimensional error occurs in the element patterns, the reflection phases in respective regions may tend to vary significantly from the design value, and the reflection intensity in the desired direction may decrease.

This raises an issue that increasing non-defective product rate for reflectarrays is difficult.

Neither PTL 1 nor PTL 2 gives sufficient consideration to the method of setting the design parameters.

In this regard, the present invention aims to provide a technique for improving the non-defective product rate for reflectarrays.

### Solution to Problems

In order to solve the above issues, one of typical reflectarrays of the present invention includes at least a layer of element patterns, a dielectric layer, and a ground layer laminated in this order, wherein the reflectarray includes at least one reflection control area; the reflection control area includes at least two unit cells; one element pattern is arranged on each unit cell; the element pattern includes a cross-patch in which two rectangular patches are orthogonal to each other in an xy plane; and in the reflection control area, a first element width wx which is a width of the element pattern in an x axis direction or/and a second element width wy which is a width of the element pattern in a y axis direction is/are different between the element patterns arranged in the respective at least two unit cells.

### Advantageous Effects of the Invention

According to the present invention, a technique for improving the non-defective product rate for reflectarrays can be provided.

Issues, configurations, and advantageous effects other than those described above will be clarified in the following embodiments for implementing the invention.

### BRIEF DESCRIPTION OF THE DRAWINGS

FIG. 1 is a diagram illustrating a configuration of a reflectarray.

FIGS. 2A-2C a set of diagrams each illustrating an arrangement example of a functional layer.

FIGS. 3A and 3B are a set of diagrams each illustrating another arrangement example of a functional layer.

FIGS. 4A and 4B are a set of diagrams illustrating an arrangement example of unit cells according to the direction in which asymmetrical reflection is to be generated.

FIGS. 5A and 5B are a set of diagrams illustrating an arrangement example of unit cells according to the direction in which asymmetrical reflection is to be generated.

FIGS. 6A-6D a set of diagrams illustrating an arrangement example of unit cells according to the direction in which asymmetrical reflection is to be generated.

FIGS. 7A-7C are a set of diagrams each illustrating a configuration of an element pattern.

FIGS. 8A and 8B are a set of diagrams each illustrating an example of a reflection control area.

FIGS. 9A-9C are a set of diagrams illustrating the case in which the element length in the x axis direction and the element length in the y axis direction are changed between reflection control areas.

FIGS. 10A-10C are a set of diagrams each illustrating an example of the shape and width of an element pattern.

FIGS. 11A-11D are a set of diagrams illustrating an example of the shape of an etched element pattern.

FIG. 12 is a diagram illustrating a structure of a reflectarray as viewed perpendicularly to the xy plane according to Example 1.

FIG. 13 is a graph showing an analysis of unit cells in a design process, i.e., showing reflection phases in which the element width of the element patterns is set to wx=wy=9.000 mm with the element length I changed, according to Comparative Example 1.

FIG. 14 is a graph showing an analysis of a reflectarray, i.e., showing reflection characteristics of the reflectarray with and without a dimensional error in the xz plane, according to Comparative Example 1.

FIG. 15 is a graph showing an analysis of unit cells in a design process, i.e., showing reflection phases in which the element length of the element patterns is set to lx=ly=15.000 mm with the element width w changed, according to Example 1.

FIG. 16 is a graph showing an analysis of a reflectarray, i.e., showing reflection patterns of the reflectarray with and without a dimensional error in the xz plane, according to Example 1.

FIG. 17 is a graph showing an analysis of unit cells in a design process, i.e., showing reflection phases in which the element width of the element patterns is set to wx=wy=1.000 mm with the element length I changed, according to Comparative Example 2.

FIG. 18 is a graph showing an analysis of a reflectarray, i.e., showing reflection characteristics of the reflectarray with and without a dimensional error in the xz plane, according to Comparative Example 2.

FIG. 19 is a graph showing an analysis of unit cells in a design process, i.e., showing reflection phases in which the element length of the element patterns is set to lx=ly=3.250 mm with the element width w changed, according to Example 2.

FIG. 20 is a graph showing an analysis of a reflectarray, i.e., showing reflection patterns of the reflectarray with and without a dimensional error in the xz plane, according to Example 2.

FIG. 21 is a graph showing an analysis of unit cells in a design process, i.e., showing reflection phases in which the element width of the element patterns is set to wx=wy=0.500 mm with the element length I changed, according to Comparative Example 3.

FIG. 22 is a graph showing an analysis of a reflectarray, i.e., showing reflection characteristics of the reflectarray with and without a dimensional error in the xz plane, according to Comparative Example 3.

FIG. 23 is a graph showing an analysis of unit cells in a design process, i.e., showing reflection phases in which the element length of the element patterns is set to lx=ly=1.700 mm with the element width w changed, according to Example 3.

FIG. 24 is a graph showing an analysis of a reflectarray, i.e., showing reflection patterns of the reflectarray with and without a dimensional error in the xz plane, according to Example 3.

FIG. 25 is a graph showing an analysis of unit cells in a design process, i.e., showing reflection phases in which the element width of the element patterns is set to wx=wy=0.400 mm with the element length I changed, according to Comparative Example 4.

FIG. 26 is a graph showing an analysis of a reflectarray, i.e., showing reflection characteristics of the reflectarray with and without a dimensional error in the xz plane, according to Comparative Example 4.

FIG. 27 is a graph showing an analysis of unit cells in a design process, i.e., showing reflection phases in which the element length of the element patterns is set to lx=ly=0.900 mm with the element width w changed, according to Example 4.

FIG. 28 is a graph showing an analysis of a reflectarray, i.e., showing reflection patterns of the reflectarray with and without a dimensional error in the xz plane, according to Example 4.

FIG. 29 is a graph showing an analysis of a reflectarray, i.e., showing reflection characteristics of the reflectarray in the xz plane, according to Example 5.

FIG. 30 is a graph showing an analysis of a reflectarray, i.e., showing reflection characteristics of the reflectarray in the xz plane, according to Example 6.

FIG. 31 is a graph showing an analysis of a reflectarray, i.e., showing reflection characteristics of the reflectarray in the xz plane, according to Example 7.

### DETAILED DESCRIPTION

Referring to the drawings, some embodiments of the present invention will be described. It should be noted that the present invention should not be construed as being limited to the following embodiments. In the drawings, components identical with each other are denoted by the same reference signs.

If there are a plurality of components having the same or similar functions, they may be described by using the same reference signs with different subscripts. If it is not necessary to distinguish between the plurality of components, the subscripts may be omitted in the description.

In order to facilitate understanding of the invention, the positions, sizes, shapes, ranges, etc. of the components shown in the drawings do not necessarily indicate the actual positions, sizes, shapes, ranges, etc. Therefore, the present disclosure is not necessarily limited to the positions, sizes, shapes, ranges, etc. disclosed in the drawings.

### Explanation of Terms

The term reflectarray (electromagnetic wave reflector) in the present disclosure refers to a component that reflects electromagnetic waves. The reflectarray may include not only a reflectarray that symmetrically reflects waves at equal angles of incidence and reflection, but also a reflectarray that asymmetrically reflects waves with different angles of incidence and reflection, a reflectarray that scatters electromagnetic waves in multiple directions, and a reflectarray that concentrates electromagnetic waves to a specific position. The following description adopts the xyz coordinate system, and the reflectarray is assumed to be disposed on the xy plane.

The term reflection control area refers to part of the area constituting the reflectarray. The reflection control area refers to a minimum area that can reflect electromagnetic waves incident on the area to a predetermined direction.

The reflectarray is constituted by combining one or more reflection control areas. The term reflection control area should include a layered structure in which electromagnetic waves are formed not only in a two-dimensional area residing in directions parallel to the incident area but also in an area residing in the direction perpendicular to this area.

The term unit cell refers to an area obtained by dividing the reflection control area. A unit cell includes one element pattern.

The symbol θi represents the incidence angle of incident waves. The incidence angle in the x axis direction is represented by θix, and the incidence angle in the y axis direction is represented by θiy. The symbol Or represents the reflection angle of reflected waves. The reflection angle in the x axis direction is represented by θrx, and the reflection angle in the y axis direction is represented by θry.

An angle θx in the x axis direction is expressed as a positive angle (00 to 180°) when it extends from the +z axis direction toward the +x axis direction, and as a negative angle (0° to −180°) when it extends from the +z axis direction toward the −x axis direction. Similarly, an angle θy in the y axis direction is expressed as a positive angle (00 to 180°) when it extends from the +z axis direction toward the +y axis direction, and as a negative angle (0° to −180°) when it extends from the +z axis direction toward the −y axis direction.

Regarding element length, the element length in the x axis direction is represented by lx, and the element length in the y axis direction is represented by ly. Regarding element width, the element width in the x axis direction is represented by wx, and the element width in the y axis direction is represented by wy.

### First Embodiment

### (Configuration of Reflectarray)

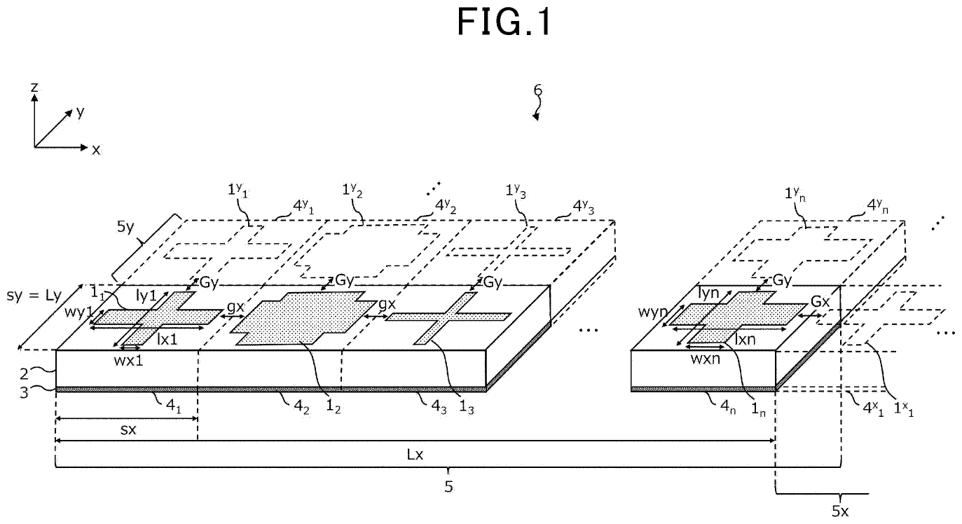

Referring to FIG. 1, the configurations of a reflectarray and an element pattern will be described. FIG. 1 is a diagram illustrating the configuration of a reflectarray 6. In the reflectarray 6, the direction of reflected waves can be set to a desired value by periodically arranging multiple element patterns in a plane. The reflectarray 6 at least includes element patterns (elements) 1, a dielectric layer 2, and a ground layer (ground plate) 3. In the following description, the xyz coordinate system is adopted, and the reflectarray 6 is arranged on the xy plane.

The reflectarray 6 shown in FIG. 1 causes predetermined asymmetrical reflection of electromagnetic waves along the x axis direction. The reflectarray 6 shown in FIG. 1 has a configuration in which multiple reflection control areas, each of which is identical with a reflection control area 5, are arranged in the x and y axis directions. FIG. 1 shows a reflection control area 5 with a solid line as a typical example of the multiple reflection control areas included in the reflectarray 6. The reflection control area 5 includes unit cells 4₁, 4₂, 4₃, . . . and 4ₙ (where n is a positive integer greater than or equal to 2, and hereinafter, the cells may be simply referred to as unit cell(s) 4 if not particularly specified). The unit cells 4 are portions of the reflection control area 5 obtained by dividing the area at even intervals in the x axis direction. n represents the number of divisions when dividing the reflection control area into unit cells in the x axis direction. When the size (length) of each unit cell 4 in the x axis direction is sx, the size thereof in the y axis direction is sy, the size of the reflection control area 5 in the x axis direction is Lx, and the size thereof in the y axis direction is Ly, relations sx=Lx/n and sy=Ly are established. In FIG. 1, the reflection control area 5 is constituted of n unit cells 4 arranged in the x axis direction, and the reflectarray 6 is configured to include multiple reflection control areas 5; however, the present disclosure is not limited to such a configuration. The reflection control area may also be constituted of the unit cells arranged in the y axis direction, or may be constituted of the unit cells arranged in the x and y axis directions. The configuration of each reflection control area will be described alter.

### (Configuration of Element Pattern)

Each of the unit cells 4 has a surface oriented to the +z axis direction in which an element pattern is formed. Using the number of divisions n, the unit cells are expressed as a unit cell 4₁, unit cell 4₂, . . . and unit cell 4ₙ. An element pattern 1i is formed on the unit cell 4₁. An element pattern 1₂ is formed on the unit cell 4₂. An element pattern 1₃ is formed on the unit cell 4₃. An element pattern 1n is formed on the unit cell 4ₙ.

The element patters are arranged at even intervals in a reflection control area and the area where identical reflection control areas are adjacent to each other. Specifically, for the element patterns in the reflection control area 5, when adjacent element patterns in the x axis direction (hereinafter, also referred to as gap) have a closest interval therebetween represented by gx, the element patterns 1₁ to 1ₙ in the reflection control area 5 are arranged at even intervals of gx. Also, when a gap between the element pattern i of the reflection control area 5 and the element pattern 1^{x}₁ of a reflection control area 5x (including a unit cell 4^{x}₁ on which an element pattern 1^{x}₁ is formed, a unit cell 4^{x}₂ on which an element pattern 12 is formed, . . . , and a unit cell 4xn on which an element pattern 1^{x}ₙ is formed as indicated by the broken lines) adjacent to the reflection control area 5 in the x axis direction is represented by Gx, Gx is equal to gx in FIG. 1.

It should be noted that the gaps between element patterns of the reflection control area 5 and corresponding element patterns of a reflection control area 5y (including a unit cell 4^{y}i on which an element pattern 1^{y}₁ is formed, a unit cell 4^{y}₂ on which an element pattern 1^{y}₂ is formed, . . . , and a unit cell 4^{y}ₙ on which an element pattern 1^{y}ₙ is formed as indicated by the broken lines) adjacent to the reflection control area 5 in the y axis direction are equal to each other and represented by Gy in FIG. 1.

In the reflection control area, each element pattern has a slightly different shape than other element patterns. In this example, the shapes of the element patterns shown in the element patterns 1₁ to 1ₙ may be referred to as cross-patches. The term cross-patch refers to a shape in which two rectangular patches are orthogonal to each other in the xy plane. The element pattern 1₁ has a shape in which a rectangular patch having an element length lx1 that is the size in the x axis direction and an element width wy1 that is the size in the y axis direction is orthogonal to a rectangular patch having an element length ly1 that is the size in the y axis direction and an element width wx1 that is the size in the x axis direction, which are mutually orthogonal with a common center of gravity. Similarly, the element pattern l i has a shape in which a rectangular patch having an element length lxn and an element width wyn is orthogonal to a rectangular patch having an element length lyn and an element width wxn, which are mutually orthogonal with a common center of gravity. The method of determining the element lengths and the element widths will be described later.

### (Explanation of Components and Design Method)

### (Configuration of Layer)

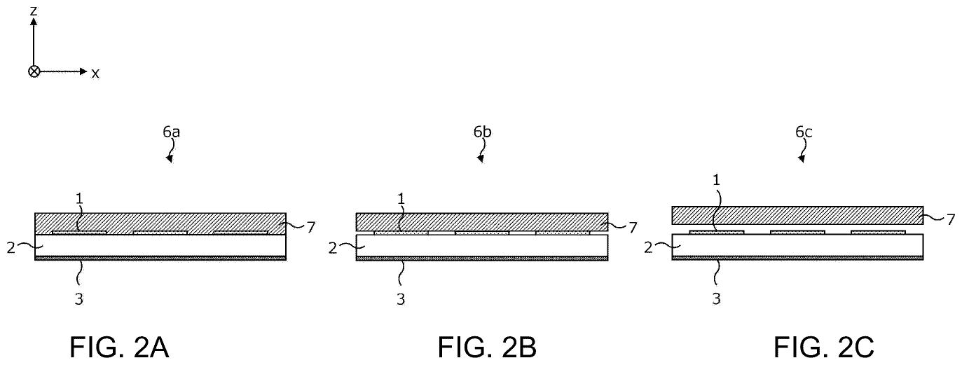

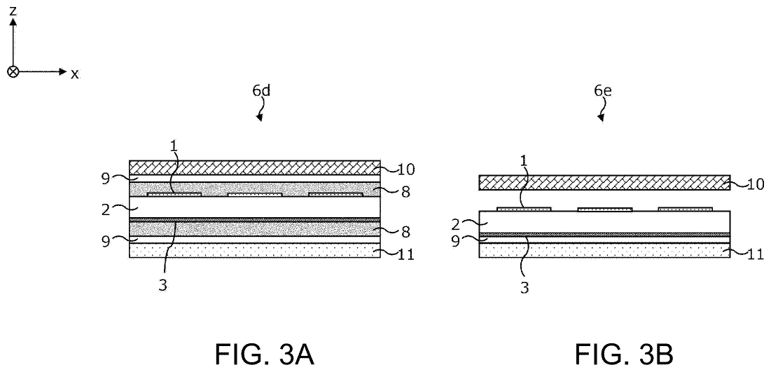

Referring to FIGS. 2A-2C, 3A, and 3B, a layer configuration of the reflectarray 6 will be described. FIGS. 2A-2C, 3A, and 3B are each a set of diagrams illustrating a layer configuration of the reflectarray 6. The reflectarray 6 has a configuration in which at least a layer of element patterns 1, a dielectric layer 2, and a ground layer 3 are laminated in the direction from +z axis to −z axis. In the following description, the configuration constituted of three layers of a layer of element patterns 1, a dielectric layer 2, and a ground layer 3 is referred to as basic structure. Practically, it is preferable that the reflectarray 6 includes at least one layer having various functions (hereinafter may also referred to as functional layer(s)) on the layer of element patterns 1 side or the ground layer 3 side, or both, of the basic structure. In the following description, layers other than the layer of element patterns 1, the electric layer 2, and the ground layer 3 included in the reflectarray may be referred to as functional layers if they are shown without specifying the types.

As necessary, a layer for improving adhesion may be provided between the layer of element patterns 1 and the dielectric layer 2 or between the ground layer 3 and the dielectric layer 2. Also, other layers used for other purposes than improving adhesion may also be formed. Intermediate products produced during the process of producing the reflectarray 6 may be formed in layers and remain in the reflectarray 6.

Examples of the functional layer include a design layer with a design taking into consideration the location where the reflectarray 6 is mounted, a mounting layer for easily mounting the reflectarray 6 on a support such as a wall or ceiling, a protective layer for protecting the basic structure, and an adhesive layer for adhesion between the functional layers.

FIGS. 2A-2C are a set of diagrams each illustrating an arrangement example of a functional layer 7. As a lamination method on the layer of element patterns 1 side, the functional layer 7 may be laminated so as to fill the gaps between the multiple element patterns 1 as in a reflectarray 6a (FIG. 2A), or the functional layer 7 may be laminated so as to be in contact with the upper surfaces of the element patterns 1 leaving the gaps therebetween as in a reflectarray 6b (FIG. 2B), or the functional layer 7 may be laminated so as not to contact the upper surfaces of the element patterns 1 as in reflectarray 6c (FIG. 2C). The reflectarrays 6a to 6c, which have a common configuration but for the configuration of the functional layer 7, have different reflection characteristics. Thus, by changing the lamination method for the functional layer 7, the characteristics of the reflectarray can be changed.

FIGS. 3A and 3B a set of diagrams each illustrating another arrangement example of a functional layer. FIGS. 3A and 3B show arrangement examples of a protective layer 8, an adhesive layer 9, a design layer 10, and a mounting layer 11, as functional layers. FIG. 3A shows a reflectarray 6d in which protective layers 8 are laminated covering the layer of element patterns 1 and the ground layer 3, respectively, a design layer 10 is provided on the layer of element patterns 1 side via an adhesive layer 9, and a mounting layer 11 is provided on the ground layer side via another adhesive layer 9. FIG. 3B shows a reflectarray 6e in which a mounting layer 11 is provided on the ground layer side via an adhesive layer 9, and a design layer 10 is provided on the layer of element patterns 1 side via a gap.

### (Reflection Control Area)

The reflectarray 6 includes at least one reflection control areas. Depending on the ways of arranging the reflection control areas, the characteristics of the reflectarray can be changed. For example, in the case where electromagnetic waves with some wavelength are incident at some incidence angle, reflection control areas having a common reflection direction may be arranged periodically, so that the reflectarray can be imparted with characteristics of reflecting the electromagnetic waves in a single direction. Also, in the case where electromagnetic waves with some wavelength are incident at some incidence angle, a reflectarray may be constituted in such a way that it includes reflection control areas having different reflection directions, so that the reflectarray can be imparted with characteristics of scattering the electromagnetic waves in multiple directions. Furthermore, the reflection direction may be shifted by a predetermined angle for each reflection control area, so that characteristics of concentrating electromagnetic waves on a specific spot can be imparted. The frequency that is planned to be applied to a reflectarray when designing it is hereinafter referred to as operating frequency.

When the wavelength corresponding to the operating frequency is λ, the x axis component of the incidence angle of the electromagnetic waves incident on the reflection control area is θix, and the x axis component of the reflection angle of the electromagnetic waves reflected from the reflection control area is θrx, and when θix≠−θrx is established, the size Lx of the reflection control area in the x axis direction may be determined, for example, according to the following Formula (1).

$$[ Math . 1 ]$$

$${L}_{x} = \frac{λ}{sin {θ}_{ix} + sin {θ}_{rx}} \qquad ( 1 )$$

Also, when the y axis component of the incidence angle of the electromagnetic waves incident on the reflection control area is θiy, and the y axis component of the reflection angle of the electromagnetic waves reflected from the reflection control area is θry, and when θiy≠−θry is established, the size Ly of the reflection control area in the y axis direction may be determined, for example, according to the following Formula (2).

$$[ Math . 2 ]$$

$${L}_{y} = \frac{λ}{sin {θ}_{iy} + sin {θ}_{ry}} \qquad ( 2 )$$

### (Relationship Between Unit Cell Sand Reflection Phase)

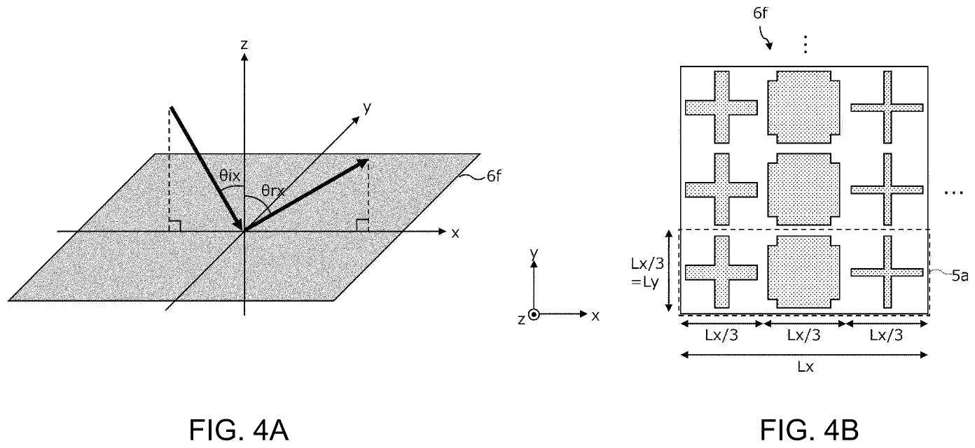

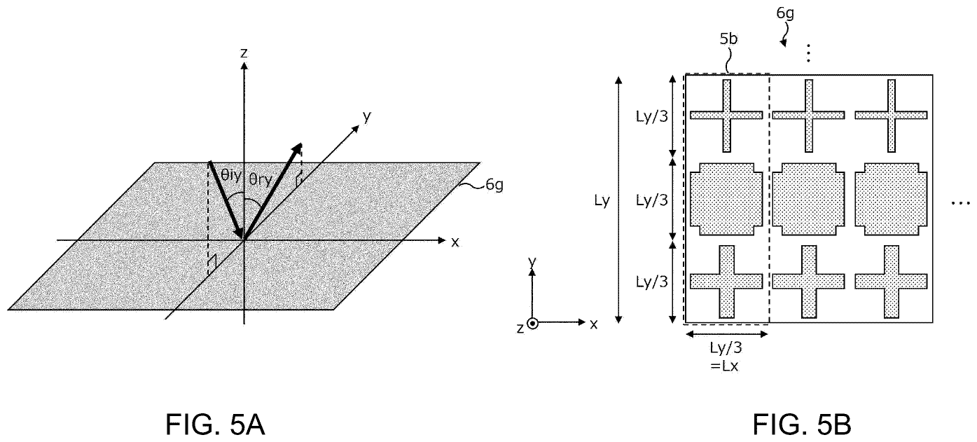

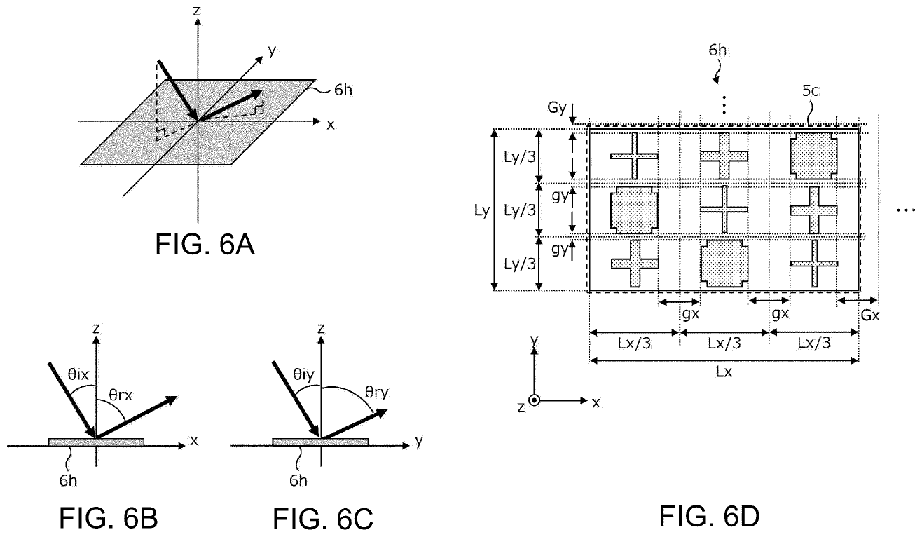

Referring to FIGS. 4A, 4B, 5A, 5B, and 6A-6D, a relationship between unit cells and reflection phase will be described. FIGS. 4A, 4B, 5A, 5B, and 6A-6D each are a set of diagrams illustrating an arrangement example of unit cells according to the direction in which asymmetrical reflection is to be generated. The reflection control area 5 includes at least two unit cells. FIG. 4A shows the direction of the electromagnetic waves (incident waves) incident on a reflectarray 6f, and the direction of the electromagnetic waves (incident waves) reflected from the reflectarray 6f. In other words, the thick solid arrows indicate the wavefront directions, with the arrow pointing toward the reflectarray 6f indicating the wavefront direction of the incident waves and the arrow pointing away from the reflectarray 6f indicating the wavefront direction of the reflected waves. FIG. 4B is a plan view illustrating the reflectarray 6f as viewed in the z axis direction. The relationships between FIGS. 5A, 5B, and 6A-6D are similar to the relationship between FIGS. 4A and 4B.

The unit cells have an effect of reflecting the incident electromagnetic waves with a predetermined phase difference. In the reflection control area, each unit cell exhibits a different reflection phase, and therefore the reflected wavefront that is the wavefront of the reflected waves generated from the reflection control area is deviated from the reflection angle that would be obtained if the incidence angle were equal to the reflection angle, achieving asymmetrical reflection which is different from symmetrical reflection in which the incidence angle is equal to the reflection angle.

When designing the reflectarray 6f performing asymmetrical reflection only in the x axis direction (θix≠−θrx as shown in FIG. 4A), unit cells exhibiting different reflection phases are arranged in the x axis direction in a reflection control area 5a (FIG. 4B). The reflection control area 5a has the number of divisions n=3 and includes three unit cells arranged in the x axis direction. The size Lx of the reflection control area 5a in the x axis direction is determined according to Formula (1), and the size of each unit cell in the x axis direction is Lx/3. When the y axis component of the reflection angle is that for symmetrical reflection (θiy=−θry) as represented by this example, Ly does not need to be determined by Formula (2) but may take any value. However, for ease of design and for convenience, a square unit cell whose size is determined from Lx and the number of divisions n may be used, and each Ly may be equally set to Lx/3.

Similarly, when designing a reflectarray 6g performing asymmetrical reflection only in the y axis direction (θiy≠−θry as shown in FIG. 5A), unit cells exhibiting different reflection phases are arranged in the y axis direction in a reflection control area 5b (FIG. 5B). In this example, m (m is a positive integer greater than or equal to 2) is the number of divisions when dividing the reflection control area into unit cells in the y axis direction. The reflection control area 5b has the number of divisions m=3 and includes three unit cells arranged in the y axis direction. The size Ly of the reflection control area 5b in the y axis direction is determined according to Formula (2), and the size of each unit cell in the y axis direction is Ly/3. Since the x axis component of the reflection angle is that for symmetrical reflection, Lx does not need to be determined by Formula (1) but may take any value. However, for ease of design and for convenience, a square unit cell whose size is determined from Ly and the number of divisions m may be used, and each Lx may be equally set to Ly/3.

FIGS. 6A-6D are a set of diagrams showing a relationship between reflectarray and electromagnetic waves, where FIG. 6B shows the electromagnetic waves projected onto the zx plane and FIG. 6C shows the electromagnetic waves projected onto the zy plane. When designing a reflectarray 6h performing asymmetrical reflection in both the x and y axis directions (θix≠−θrx as shown in FIG. 6B and θiy≠−θry as shown in FIG. 6C), unit cells exhibiting different reflection phases are arranged in the x axis direction in a reflection control area 5c, and unit cells exhibiting different reflection phases are arranged in the y axis direction also (FIG. 6D). The reflection control area 5c includes nine unit cells where three unit cells are arranged in the x axis direction and three unit cells are arranged in the y axis direction. The number of divisions in the reflection control area 5c may be expressed by 3×3=9 using the number of divisions n=3 in the x axis direction and the number of divisions m=3 in the y axis direction. The size Lx of the reflection control area 5c in the x axis direction is determined according to Formula (1), and the size Ly in the y axis direction is determined according to Formula (2). The size of each unit cell in the x axis direction is determined from Lx and n, and expressed as Lx/3. The size of each unit cell in the y axis direction is determined from Ly and m, and expressed as Ly/3. Both the x axis and y axis components of the incident waves are for asymmetrical reflection. Therefore, the x axis component of the reflected wavefront is different from the x axis component of the incident wavefront, and the y axis component of the reflected wavefront is different from the y axis component of the incident wavefront (FIG. 6A).

gx represents a gap between the element patterns in the x axis direction in the reflection control area 5c. gy represents a gap between the element patterns in the y axis direction in the reflection control area 5c. The intervals gx between the element patterns in the x axis direction are uniform, and the intervals gy between the element patterns in the y axis direction are uniform. Although gx differs from gy in the example shown, they may be equal to each other.

Gx represents a gap between the element patterns of the reflection control area 5c and the element patterns of a reflection control area adjacent to the reflection control area 5c in the x axis direction. Gy represents a gap between the element patterns of the reflection control area 5c and the element patterns of a reflection control area adjacent to the reflection control area 5c in the y axis direction. When a reflection control area identical to the reflection control area 5c is adjacently located in the y axis direction (or in the x axis direction), and these are parallel to each other in the x axis direction (or in the y axis direction), gx is equal to Gx, and gy is equal to Gy.

### (Reflection Phase Distribution and Surface Impedance Distribution in Reflection Control Area)

Reflection phase distribution in the reflection control area may be determined, for example, according to Formulas (3) and (4). In the formulas, the wavelength of the operating frequency is λ(m), the x axis component of the incidence angle of the electromagnetic waves incident on the reflection control area is θix, the y axis component thereof is θiy, the x axis component of the reflection angle of the electromagnetic waves reflected from the reflection control area is θrx, the y axis component thereof is θry, the reflection phases at arbitrary coordinates x1 and x2 parallel to the x axis within the reflection control area are φx1 and φx2, respectively, the distance between the coordinates x1 and x2 is dx, and the reflection phase difference between Φx1 and Φx2 is ΔΦx. Furthermore, the reflection phases at arbitrary coordinates y1 and y2 parallel to the y axis are respectively represented by φy1 and φy2. If asymmetrical reflection is to be performed in the reflection control area in the x axis direction, it is preferable that Formula (3) be satisfied, and if asymmetrical reflection is to be performed in the reflection control area in the y axis direction, it is preferable that Formula (4) be satisfied. If asymmetrical reflection is to be performed in the reflection control are in both the x and y axis directions, it is preferable that both of Formulas (3) and (4) be satisfied.

$$[ Math . 3 ]$$

$$Δ {∅}_{x} = 2 π \frac{{d}_{x}}{λ} \vert sin {θ}_{ix} + sin {θ}_{rx} \vert \qquad ( 3 )$$

$$[ Math . 4 ]$$

$$Δ {∅}_{y} = 2 π \frac{{d}_{y}}{λ} \vert sin {θ}_{iy} + sin {θ}_{ry} \vert \qquad ( 4 )$$

Also, instead of the reflection phase, surface impedance distribution can be applied to the reflection control area. In this case, the surface impedance distribution may be expressed, for example, by Formulas (5) and (6). In the formulas, Zsx represents the surface impedance distribution parallel to the x axis direction of the reflection control area, Zsy represents the surface impedance distribution parallel to the y axis direction of the reflection control area, and η1 represents the impedance of the incident waves. Also, the x axis component of the incidence angle of the electromagnetic waves incident on the reflection control area is θix, the y axis component thereof is θiy, the x axis component of the reflection angle of the electromagnetic waves reflected from the reflection control area is θrx, and the y axis component thereof is θry.

It should be noted that x1 and x2 indicate x coordinates as relative coordinates within the reflection control area, and the reference x=0 can be established at any coordinate within the reflection control area. Similarly, y1 and y2 indicate y coordinates as relative coordinates within the reflection control area, and the reference y=0 can be established at any coordinate within the reflection control area.

ki represents the wavenumber of the reflected waves. j represents the imaginary unit. If asymmetrical reflection is to be performed in the reflection control area in the x axis direction, it is preferable that Formula (5) be satisfied, and if asymmetrical reflection is to be performed in the reflection control area in the y axis direction, it is preferable that Formula (6) be satisfied. If asymmetrical reflection is to be performed in the reflection control area in both the x and y axis directions, it is preferable that both of Formulas (5) and (6) be satisfied.

$$[ Math . 5 ]$$

$${Z}_{sx} = {n}_{1} \frac{1 + {e}^{[ j ( - sin {θ}_{ix} - sin {θ}_{rx} ) {k}_{1} x ]}}{cos {θ}_{ix} - cos {θ}_{rx} {e}^{[ j ( - sin {θ}_{ix} - sin {θ}_{rx} ) {k}_{1} x ]}} \qquad ( 5 )$$

$$[ Math . 6 ]$$

$${Z}_{sy} = {n}_{1} \frac{1 + {e}^{[ j ( - sin {θ}_{iy} - sin {θ}_{ry} ) {k}_{1} y ]}}{cos {θ}_{iy} - cos {θ}_{ry} {e}^{[ j ( - sin {θ}_{iy} - sin {θ}_{ry} ) {k}_{1} y ]}} \qquad ( 6 )$$

Other surface impedance distributions may be expressed, for example, by Formulas (7) and (8). If asymmetrical reflection is to be performed in the reflection control area only in the x axis direction, it is preferable that Formula (7) be satisfied, and if asymmetrical reflection is to be performed in the reflection control area only in the y axis direction, it is preferable that Formula (8) be satisfied. If asymmetrical reflection is to be performed in the reflection control area in both the x and y axis directions, it is preferable that both of Formulas (7) and (8) be simultaneously satisfied.

$$[ Math . 7 ]$$

$${Z}_{sx} = \frac{{η}_{1}}{\sqrt{cos {θ}_{ix} cos {θ}_{rx}}} \frac{\sqrt{cos {θ}_{rx}} + \sqrt{cos {θ}_{ix}} {e}^{[ j ( - sin {θ}_{ix} - sin {θ}_{rx} ) {k}_{1} x ]}}{\sqrt{cos {θ}_{ix}} - \sqrt{cos {θ}_{rx}} {e}^{[ j ( - sin {θ}_{ix} - sin {θ}_{rx} ) {k}_{1} x ]}} \qquad ( 7 )$$

$$[ Math . 8 ]$$

$${Z}_{sy} = \frac{{η}_{I}}{\sqrt{cos {θ}_{iy} cos {θ}_{ry}}} \frac{\sqrt{cos {θ}_{ry}} + \sqrt{cos {θ}_{iy}} {e}^{[ j ( - sin {θ}_{ix} - sin {θ}_{rx} ) {k}_{1} y ]}}{\sqrt{cos {θ}_{iv}} - \sqrt{cos {θ}_{rv}} {e}^{[ j ( - sin {θ}_{iy} - sin {θ}_{ry} ) {k}_{1} y ]}} \qquad ( 8 )$$

The above Formulas (3) to (8) are only examples of design formulas used when designing reflection phase distributions and surface impedance distributions. The present disclosure should not be limited to the cases where these Formulas (3) to (8) are used, but other design formulas can be appropriately selected.

### (Element Pattern)

Referring to FIGS. 1 and 7A to 10C, element patterns will be described in detail. Generally, reflectarrays change their reflection characteristics by utilizing resonances caused by the element patterns. It is known that a linear or rectangular element pattern (square patches) mainly resonates with polarized waves in the long-axis direction, and therefore when an element pattern with a shape in which these patches are orthogonal to each other is used, both TE and TM polarized waves can be accommodated.

In the reflectarray of the present disclosure, the larger the number of divisions n and m of the reflection control area, the smaller the size of each unit cell and the size of each element pattern. Resonance occurs only when a predetermined element pattern size is satisfied with respect to the frequency, and therefore if n and m are increased beyond the predetermined level, asymmetrical reflection at the operating frequency becomes difficult to achieve. On the other hand, the larger n and m are, the more the reflection characteristics can be controlled for each smaller region, and therefore the reflection characteristics of the reflectarray approach theoretical characteristics.

The element patterns of the present disclosure have shapes including cross-patches in each of which two rectangular patches are orthogonal to each other in the xy plane. As shown in FIG. 1, the rectangular patch, which constitutes a cross-patch and has a long side in the x axis direction, has the element length lx that is the size of the long side and the element width wy that is the size of the short side, and the rectangular patch, which has a long side in the y axis direction, has the element length ly that is the size of the long side and the element width wx that is the size of the short side. Accordingly, the element pattern in a unit cell 4n can be expressed as having element lengths lxn and lyn and element widths wxn and wyn.

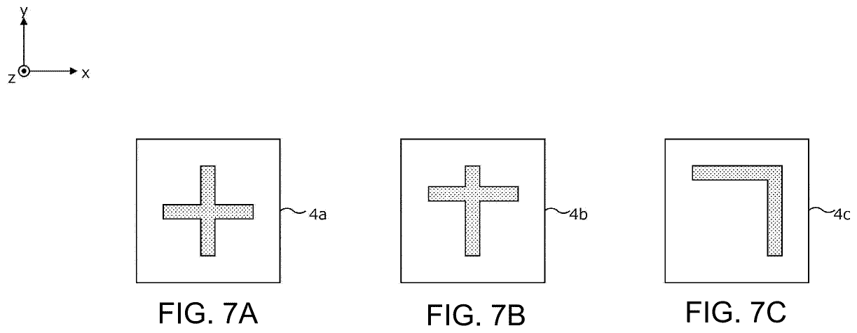

FIGS. 7A-7C are a set of diagrams each illustrating a configuration of an element pattern. One element pattern is arranged on each unit cell. In the cross-patch constituting the element pattern of a unit cell 4, the orthogonal position of the two rectangular patches may match the center of gravity of the unit cell (the unit cell 4a of FIG. 7A), or may be different from the center of gravity (the unit cell 4b of FIG. 7B and the unit cell 4c of FIG. 7C). Modifications of the cross-patch can be appropriately selected, by which flexibility and extensibility in design can be enhanced.

In the present disclosure, element widths wx and wy are treated as design parameters, and the element patterns included in the reflection control area are designed to have different element widths between the patterns. The element width wx can be changed within a range up to a value equal to the element length lx, and the element width wy can be changed within a range up to a value equal to the element length ly. The element widths wx and wy in one element pattern may be equal to or different from each other. If these widths are different from each other, the characteristics for the TE and TM polarized waves can be controlled separately.

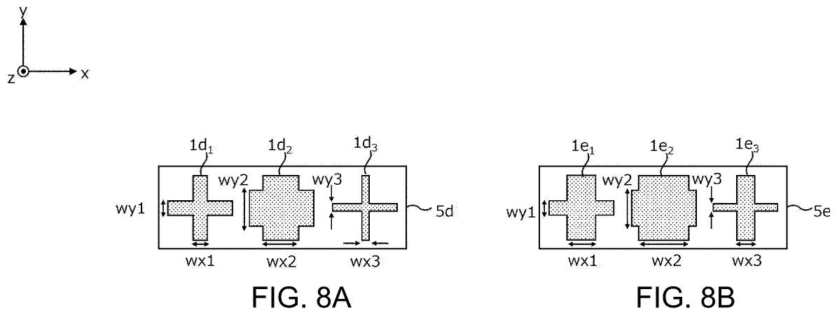

FIGS. 8A and 8B are a set of diagrams each illustrating an example of reflection control area. FIG. 8A shows an example in which the element widths wx and wy are equal to each other in one element pattern, and FIG. 8B shows an example in which the element widths wx and wy are different from each other. In these examples, n=3, the element pattern shape is made up of only two rectangular patches orthogonal to each other, and lx and ly are equal to each other. On the other hand, in the reflection control area, a first element width wx which is the width of the element pattern in the x axis direction and/or a second element width wy which is the width in the y axis direction are/is different between the element patterns arranged in the respective unit cells. When FIGS. 8A and 8B described in detail, in a reflection control area 5d of FIG. 8A, the element width wx1 in the x axis direction of the element pattern idl is equal to the element width wy1 in the y axis direction. The element width wx2 in the x axis direction of the element pattern ld2 is equal to the element width wy2 in the y axis direction. The element width wx3 in the x axis direction of the element pattern 1d3 is equal to the element width wy3 in the y axis direction. On the other hand, in a reflection control area 5e of FIG. 8B, the element width wx1 in the x axis direction of the element pattern 1e1 is larger than the element width wy1 in the y axis direction. The element width wx2 in the x axis direction of the element pattern le2 is larger than the element width wy2 in the y axis direction. The element width wx3 in the x axis direction of the element pattern le3 is larger than the element width wy3 in the y axis direction.

In the reflection control areas described so far, the element lengths lx in the x axis direction are equal and the element lengths ly in the y axis direction are equal, between the element patterns. lx and ly may be the same or may be different. If lx and ly are different, the element patterns can be individually imparted with characteristics for the TE and TM polarized waves.

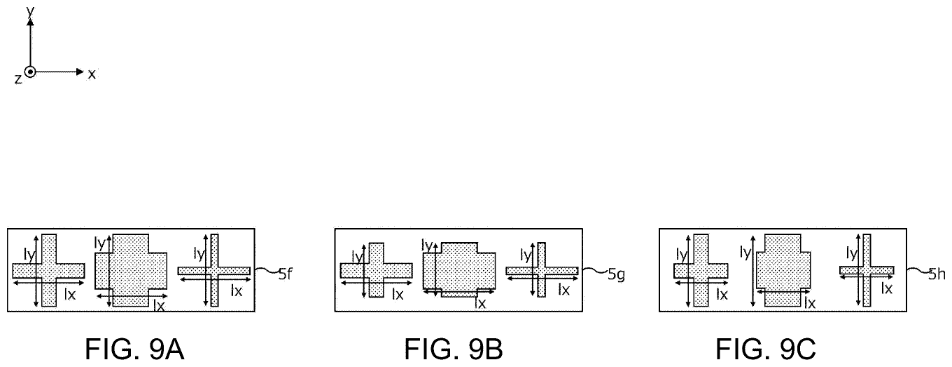

FIGS. 9A-9C are a set of diagrams illustrating the case in which the element length in the x axis direction and the element length in the y axis direction are changed between reflection control areas. FIG. 9A shows an example in which lx and ly are equal to each other, FIG. 9B shows an example in which lx>ly, and FIG. 9C shows an example in which lx<ly. In these examples, n=3, the element pattern shape is made up of only two rectangular patches orthogonal to each other, and wx and wy are equal to each other in each element pattern. Specifically, in a reflection control area 5f of FIG. 9A, all of the element patterns have an element length lx in the x axis direction and an element length ly in the y axis direction. In a reflection control area 5g of FIG. 9B and a reflection control area 5h of FIG. 9C also, the element lengths lx and ly are common between the element patterns.

Regarding the gap, there are cases where only gx is equal between the element patterns of a reflection control area, where only gy is equal between the element patterns of a reflection control area, where gx and gy are each equal between the element patterns but gx gy in a reflection control area, and where gx and gy are each equal between the element patterns and gx=gy in a reflection control area.

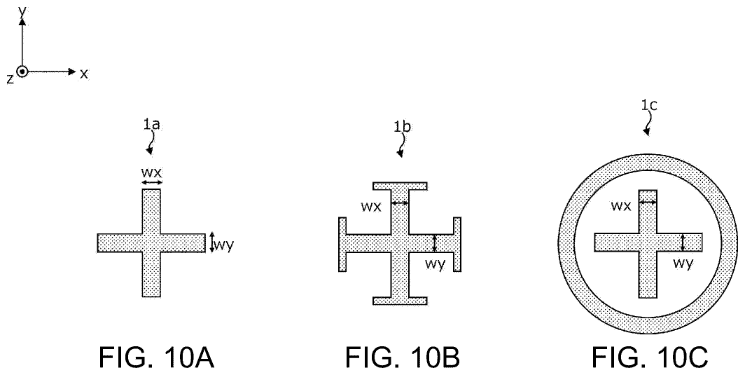

FIGS. 10A-10C a set of diagrams each illustrating an example of the shape and width of an element pattern. FIG. 10A shows an element pattern la in which the rectangular patches are orthogonal to each other, and FIG. 10B shows an element pattern lb with a shape which is commonly known as a Jerusalem Cross. FIG. 10C shows an element pattern lc in which a ring is arranged surrounding the shape shown in FIG. 10A. As shown in element patterns la to 1c, two rectangular patches are orthogonal to each other and have a common center of gravity, and the shape of each element pattern in the xy plane is symmetric about the x axis and y axis. Although in the case shown herein, the element patterns are orthogonal to each other and have a common center of gravity, the present disclosure should not be limited to this. The two patches may be orthogonal to each other without having a common center of gravity.

### (Production Method)

A main method of producing the basic structure of a reflectarray includes forming an element pattern by cutting, etching, etc. a copper-clad laminate used for printed circuit boards, etc. or a dielectric layer in which a metal film is formed on one side or both sides thereof by dry coating of vapor deposition or sputtering, or by plating, wet coating, etc.

Specifically, for example, the copper-clad laminate may be obtained by laminating a copper foil on an insulator obtained by impregnating a base material such as glass cloth with a resin such as epoxy. The copper-clad laminate has a plate shape in which a copper foil is laminated on each of both sides of a plate-shaped insulator. The copper foil on one side is applied to element patterns 1 and the copper foil on the other side is applied to a ground layer 3. The insulator corresponds to the dielectric layer 2.

When forming metal films on respective both sides of a dielectric, element patterns 1 are formed on the metal film on one side, and the other metal film is applied to a ground layer 3. The dielectric serves as the dielectric layer 2.

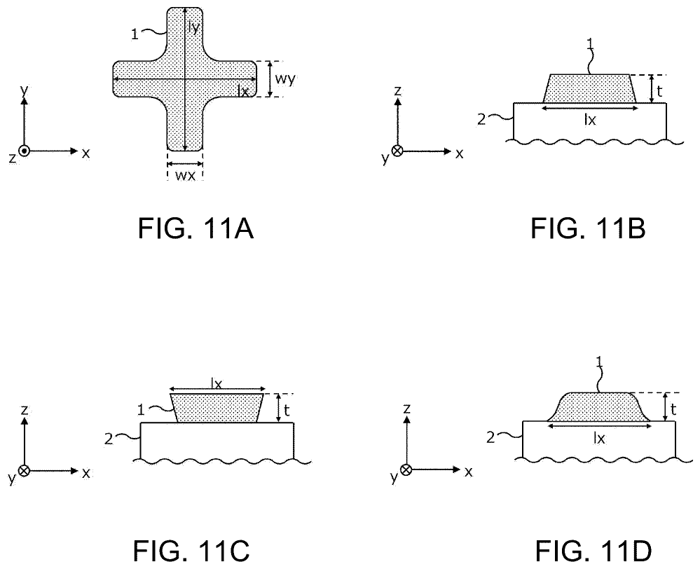

FIGS. 11A-11D are a set of diagrams illustrating an example of the shape of an etched element pattern. FIG. 11A is a plan view of an element pattern 1, and FIGS. 11B to 11D are cross-sectional views of the element pattern 1. As shown in FIG. 11A, in the element pattern 1 formed, a rectangular patch having an element length lx and an element width wy is arranged orthogonally to a rectangular patch having an element length ly and an element length wx. The etching method may be either dry etching or wet etching. If an etching method is used, corner rounding (FIG. 11A) or pinholes may occur in the element pattern 1. As can be seen in the cross-sectional views of the element pattern 1, it is assumed that a forward taper (FIG. 11B), a reverse taper (FIG. 11C), or rounding (FIG. 11D) may be formed. In FIGS. 11A-11D, the thickness of the element pattern 1 is represented by t. If an etching method is used, the element pattern preferably has a cross-sectional shape which is a forward taper shape flaring outward in the −z axis direction. The forward taper can increase the surface area of the element pattern and increase adhesion to a functional layer when the functional layer is laminated on the element.

Due to the materials or the production processes, warpage with a radius of curvature R of about 10 μm may occur in the final reflectarray product.

If a shape change occurs as mentioned above, and if the change only causes a change of about ±5° in the direction of the main beams, the change is regarded as being acceptable in the reflection characteristics of the reflectarray.

Generally, in the case of cutting, the dimensional error of the element pattern is around ±100 μm, and in the case of etching, the dimensional error of the element pattern is around ±50 km.

Other production methods may include a method in which element patterns and a ground layer are directly formed on a dielectric layer. Element patterns can also be formed by printing using letterpress printing, lithographic printing, intaglio printing, stencil printing, transfer printing, etc., or by masking the dielectric layer with a masking tape or a masking agent, etc., except for the element pattern portions, followed by forming element patterns by dry coating, plating, painting, or spraying.

When laminating other layers (functional layers 7 such as protective layer 8, adhesive layer 9, design layer 10, and mounting layer 11) on the basic structure, bonding, printing, coating, extrusion may be used, and examples of the bonding include dry lamination, wet lamination, thermal lamination, and extrusion lamination; however, methods are not limited to these.

If there is a need for a large size reflectarray, multiple reflect arrays may be arranged to constitute one reflectarray. In this case, when performing mounting, it is expected that misalignment may occur between the reflectarrays in the x axis direction, or misalignment may occur in the y axis direction, or gaps of about 5 mm may be formed between the reflectarrays. Also, it is expected that the individual reflectarrays may be shifted in the direction of rotation by about 5° in the xy plane.

Even when any of the above changes occurs, and if the change only causes a change of about ±5° in the direction of the main beams, the change is regarded as being acceptable in the reflection characteristics of the reflectarray.

### (Element Pattern)

An element pattern preferably has a surface resistance of 100 Ω/sq. or lower. Materials used for element patterns include electrically conductive materials such as inorganic oxide materials, metal materials, and conductive organic materials. Examples of the inorganic oxide materials and metal materials include indium tin oxide (ITO), indium zinc oxide (IZO), aluminum zinc oxide (AZO), gallium zinc oxide (GZO), antimony tin oxide, Ag, Al, Au, Pt, Pd, Cu, Co, Cr, In, Ag—Cu, Cu—Au, and Ni. Nanoparticles or nanowires containing at least one of these materials may be used. Examples of the conductive organic materials include polythiophene derivatives, polyacetylene derivatives, polyaniline derivatives, polypyrrole derivatives, carbon nanotubes, and graphene. In terms of material cost, conductivity, and film formability in particular, Cu or Al is preferable. A reflectarray having transparency can also be formed using a mixture (PEDOT/PSS) of ITO or polyethylenedioxythiophene (PEDOT) and polystyrene sulfonate (PSS). Each element pattern may have a thickness, for example, of 10 nm or greater and 18 μm or less. From the perspective of flexibility, film-formability, stability, sheet resistance, and cost, it is preferable to use a film formed by a vapor deposition method for element patterns.

The material used for the element patterns may be the same as or different from that of the ground layer. For example, at least either of the ground layer and the layer of element patterns can be formed of Cu or Al. Since Cu has excellent electrical conductivity, conductor loss can be reduced. Since Al has a low density, is lightweight, and is available at low cost, a lightweight and inexpensive reflectarray can be formed. At least either of the ground layer and the layer of element patterns may have a thickness of 1 μm or less. A thickness of 1 μm or less can improve flexibility, allows the reflectarray to be easily mounted on a curved surface, etc., and can achieve weight reduction.

The above materials can be used in the form of a continuous film, mesh, or punched shape.

If the layer of element patterns is in a mesh form, the line width of the mesh is preferably 5 μm or greater and 30 μm or less, and more preferably 6 μm or greater and 15 μm or less. The mesh line spacing is preferably 50 μm or greater and 500 μm or less, and more preferably 100 μm or greater and 300 μm or less. When the wavelength at the operating frequency is λ, the mesh line spacing is preferably 0.5×λ, or less, more preferably 0.1×λ, or less, and even more preferably 0.01×λ, or less. If the mesh line spacing is 0.5×λ or less, the performance can be ensured. The mesh line spacing may be 0.001×λ or greater.

If the layer of element patterns is in a mesh form or made of a transparent conductive material, the reflectarray can be transparent to visible light and can maintain its appearance after mounting.

If the layer of element patterns is in the form of a thin film, flexibility of the reflectarray can be improved, which leads to usage on a curved surface or to achieving roll-to-roll production processing.

If the layer of element patterns is formed using a thin film, its thickness is preferably greater than the skin depth calculated from Formula (9). In the formula, d represents skin depth, ω represents angular frequency, μ represents magnetic permeability of material, and σ represents conductivity of material.

$$[ Math . 9 ]$$

$$d = \sqrt{\frac{2}{ω μ σ}} \qquad ( 9 )$$

In order to increase reflection efficiency of electromagnetic waves, the loss due to the element patterns may be reduced. Therefore, the surface roughness of the element patterns is preferably small.

### (Dielectric Layer)

For the dielectric layer, a composite material obtained by impregnating a resin into paper, glass fibers, carbon fibers, etc. can be used, other than a simple substance of a resin.

Examples of the simple substance of a resin include polyethylenes (εr=2.2 to 2.4), polypropylenes (εr=2.0 to 2.6), polystyrenes (εr=2.4 to 2.6), polyvinyl chlorides (εr=0.8 to 8.0), AS resins (εr=2.6 to 3.1), ABS resins (εr=2.4 to 4.1), polyethylene terephthalates (εr=2.9 to 3.0), acrylic resins (εr=2.7 to 4.5), urethane resins (εr=4.0 to 7.1), epoxy resins (εr=2.5 to 6.0), nylons (εr=3.0 to 5.0), polyimides (εr=2.4 to 2.7), fluororesins (εr=2.0 to 2.6), polycarbonates (εr=2.9 to 8.9), polyphenylene ethers (εr=2.8 to 8.2), polyphenylene sulfides (εr=3.2 to 4.6), polyvinylidene fluorides (εr=6.4 to 10.0), polyethylene naphthalates (εr=2.9), phenolic resins (εr=3.0 to 12.0), and cycloolefin polymers (εr=2.3 to 2.5). Er represents dielectric constant. Of these materials, polyethylene terephthalates (PETs) are preferable because they are inexpensive and highly versatile. The dielectric layer may have a single-layer or multilayer structure. The dielectric layer may be made of a foam obtained by foaming the above materials. As the foam, a foam having high flexibility is preferably used.

Examples of the composite material include paper/phenolic resin, paper/epoxy resin, glass/epoxy resin, and glass/fluororesin.

Other than these, mixtures such as a mixture of different resin components, and a mixture of a dielectric compound and a resin component may be used. The dielectric constant of a mixture can be adjusted according to the dielectric compound selected and the content thereof.

For example, the dielectric constant of a mixture can be predicted using the Maxwell-Garnett law. In a mixture of a dielectric A having a dielectric constant εa and a dielectric B having a dielectric constant Fb, when the volume fraction of A is represented by δa, a dielectric constant Pm of the mixture can be expressed by Relational Formula (10).

$$[ Math . 10 ]$$

$$( \frac{{ε}_{m} - {ε}_{b}}{{ε}_{m} + 2 {ε}_{b}} ) = {δ}_{a} ( \frac{{ε}_{a} - {ε}_{b}}{{ε}_{a} + 2 {ε}_{b}} ) \qquad ( 10 )$$

Examples of the dielectric compound include barium titanate (εr=250 to 20,000), titanium oxide (εr=83 to 183), lead zirconate titanate, strontium tantalate bismuthate, and bismuth ferrite.

If a transparent dielectric is used, the reflectarray can be transparent to visible light and can maintain its appearance after mounting.

The dielectric layer preferably has a dielectric constant in the range of 1 or higher and 20 or lower, more preferably in the range of 1 or higher and 10 or lower, and even more preferably in the range of 2 or higher and 4 or lower. If the dielectric constant is within the above range, desired reflection phase characteristics can be easily achieved in the reflectarray 1. The dielectric tangent is preferably in the range of 0.00005 or greater and 0.01 or less, and more preferably in the range of 0.00005 or greater and 0.001 or less. With the above range, a reflectarray 1 with a low dielectric loss can be produced.

For example, the dielectric layer can be formed using wet coating such as die coating, comma coating, and gravure coating, a melt extrusion method such as T-die and inflation method, calendar film forming method, solution casting method, or heat press method. A coextrusion method in which multiple resins are extruded in multiple layers may be used to form a film.

The thickness of the dielectric layer is appropriately selected according to the design frequency. If the design frequency is 28 GHz, the thickness is preferably 40 μm or greater and 250 μm or less, and more preferably 50 μm or greater and 200 μm or less. If the thickness is excessively small, maintaining the reflection phase may become difficult, and the reflectarray 1 may become difficult to design. If the thickness is excessively large also, maintaining the reflection phase tends to become difficult, no flexibility tends to be imparted, or the total thickness of the reflectarray tends to increase, and it may become difficult to save space. Therefore, the dielectric layer preferably has a thickness of 250 μm or less. If the design frequency is 60 GHz, the thickness of the dielectric layer is preferably 10 μm or greater and 250 μm or less. If the design frequency is 100 GHz or higher and if the thickness of the dielectric layer is several m or greater and smaller than and equal to about 100 μm, the reflectarray can be easily designed.

### (Ground Layer)

The ground layer is provided to reflect electromagnetic waves that have reached the reflectarray. Also, the ground layer is used for supporting and protecting the dielectric layer. Materials used for the ground layer include electrically conductive materials such as inorganic oxide materials, metal materials, and conductive organic materials.

Examples of the inorganic oxide materials and metal materials include indium tin oxide (ITO), indium zinc oxide (IZO), aluminum zinc oxide (AZO), gallium zinc oxide (GZO), antimony tin oxide, Ag, Al, Au, Pt, Pd, Cu, Co, Cr, In, Ag—Cu, Cu—Au, and Ni. Nanoparticles or nanowires containing at least one of these materials may be used. Examples of the conductive organic materials include polythiophene derivatives, polyacetylene derivatives, polyaniline derivatives, polypyrrole derivatives, carbon nanotubes, and graphene. In terms of material cost, conductivity, and film formability in particular, Cu or Al is preferable. In order to reflect electromagnetic waves, the surface resistance of the ground layer is preferably 100 Q/sq. or lower, and if this condition can be satisfied, a reflectarray having transparency can also be formed using a mixture (PEDOT/PSS) of ITO or polyethylenedioxythiophene (PEDOT) and polystyrene sulfonate (PSS).

The above materials can be used in the form of a continuous film, mesh, punched shape, or periodic structure.

The term mesh refers to a state in which a mesh-like perforation (opening) is formed in the plane of a conductor. If the conductor is formed in a mesh, the mesh may be rectangular or diamond shaped. If a rectangular mesh is formed, the mesh is preferably square. With the square mesh, good aesthetic properties can be achieved. The mesh may have a random shape produced by a self-organizing method. With the random shape, moiré effect can be prevented. If metal is processed into a mesh shape, a method of punching, etching, etc. of a metal plate can be used.

If the ground layer is in a mesh form or made of a transparent conductive material, the reflectarray can be transparent to visible light and can maintain its appearance after mounting.

If the ground layer is in a mesh form, the line width of the mesh is preferably 5 μm or greater and 30 μm or less, and more preferably 6 μm or greater and 15 μm or less. The mesh line spacing is preferably 50 μm or greater and 500 μm or less, and more preferably 100 m or greater and 300 μm or less. When the wavelength at the operating frequency is X, the mesh line spacing is preferably 0.5×λ, or less, more preferably 0.1×λ, or less, and even more preferably 0.01×λ, or less. If the mesh line spacing is 0.5×λ, or less, the performance can be ensured. The mesh line spacing may be 0.001×λ or greater.

When using a metal material, the method of forming the ground layer may be selected from dry coating such as sputtering and vapor deposition, wet coating such as gravure coating and die coating using an ink made from the metal material, and surface treatment such as plating. Alternatively, the ground layer may be a rolled metal plate. If an inorganic oxide material is used, dry coating may be selected as a method of forming the ground layer 11. If an organic material is used, wet coating may be selected as a method of forming the ground layer 11. Alternatively, the ground layer may be formed using painting or spraying.

If the ground layer is in the form of a thin film formed by plating, vapor deposition, etc., flexibility of the reflectarray can be improved, which leads to usage on a curved surface or to achieving roll-to-roll production processing.

If the ground layer is in the form of a thin film, the thickness is preferably greater than the skin depth calculated from Formula (9) similarly to the layer of element patterns.

In order to increase the reflection efficiency of electromagnetic waves, the loss due to the ground layer may be reduced. Therefore, the surface roughness of the ground layer is preferably lower.

If the ground layer has a periodic structure, a function of selectively reflecting or transmitting a specific frequency can be exhibited. For example, if a structure in which patch-shaped conductive patterns are periodically arranged is used, a specific frequency alone can be reflected, thereby imparting a function of transmitting a specific frequency other than the operating frequency. In the case of using a structure in which portions with no conductive material are periodically provided as holes, it is possible to design a reflectarray which asymmetrically reflects the operating frequency while transmitting only the specific frequency.

### (Support)

The reflectarray is mounted on a support. As the support, panels or poles may be newly installed, or an existing signboard, wall, ceiling, etc. may be used. The support preferably has a mechanism with which the angle of the reflectarray can be adjusted up/down or right/left, and more preferably has a mechanism with which the position of the reflectarray can be moved up/down or right/left. The reflectarray mounted on the support is used as a reflectarray device.

### (Mounting Layer)

The mounting layer is a layer for fixing the reflectarray to the support. For example, an adhesive layer may be used and, if the support is made of metal, a magnet may be used. If a magnet is used, the position and angle of the reflectarray can be easily changed.

### (Design Layer)

The design layer is a layer imparting aesthetic properties to the surface of the reflectarray. For example, when used for building materials such as wallpaper, a design layer may be additionally provided for harmonization with a space. When used as a whiteboard, a functional film may be used as a design layer. The design layer may be imparted with a function of a protective layer described below.

### (Protective Layer)

As the protective layer, a film or sheet having gas barrier properties, water vapor barrier properties, water resistance, abrasion resistance, and scratch resistance may be used, in order to prevent oxidation deterioration, physical scratches, or peeling of the element patterns and the ground layer.

If the reflectarray is assumed to be used indoors, it is preferable to use a protective layer having antibacterial, antiviral, stain resistance, or other properties. If the reflectarray is assumed to be used outdoors, weather resistance is needed, and therefore it is preferable to use a layer containing a UVA (UV absorber) or HALS (photostabilizer).

### Evaluation Results (Examples and Comparative Examples)

For Examples 1 to 4 and Comparative Examples 1 to 4, the results are shown in Table 1, and for Examples 5 to 7, the results are shown in Table 2.

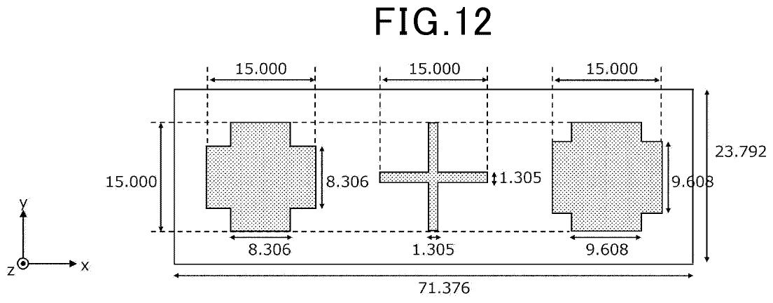

FIG. 12 is a diagram illustrating a structure of a reflectarray as viewed perpendicularly to the xy plane according to Example 1. The unit of dimension in the figure is mm.

TABLE 1

| | | | Comp. | | | | Comp. | | | |
|---|---|---|---|---|---|---|---|---|---|---|
| | Ex. 1 | | Ex. 1 | | Ex. 2 | | Ex. 2 | | Ex. 3 | |
| Operating | 4.85 | GHz | | | 27.2 | GHz | | | 60 | GHz |
| frequency | | | | | | | | | | |
| Design | Element | | Element | | Element | | Element | | Element | |
| parameter | width w | | length l | | width w | | length l | | width w | |
| Design | −60°0 | | ← | | 33°/0° | | ← | | 0°45° | |
| angle | | | | | | | | | | |
| (θixθrx) | | | | | | | | | | |
| Size Lx of | 71.376 | mm | ← | | 20.238 | mm | ← | | 7.065 | mm |
| reflection | | | | | | | | | | |
| control | | | | | | | | | | |
| area | | | | | | | | | | |
| Number of | 3 | | ← | | 3 | | ← | | 3 | |
| divisions n | | | | | | | | | | |
| of | | | | | | | | | | |
| reflection | | | | | | | | | | |
| control | | | | | | | | | | |
| area | | | | | | | | | | |
| Size of | 23.792 | mm | ← | | 6.746 | mm | ← | | 2.355 | mm |
| unit cell | | | | | | | | | | |
| Element | Material | | Copper | | ← | | Copper | | ← | |
| | Thickness | | 0.018 | mm | ← | | 0.018 | mm | ← | |
| | Material | | σ = 5.8x | | ← | | σ = 5.8x | | ← | |
| | properties | | 10\hat{ }7 S/m | | | | 10\hat{ }7 S/m | | | |
| Dielectric | Material | | Glass/epoxy | | ← | | Glass/ | | ← | |
| | | | resin | | | | fluororesin | | | |
| | Thickness | | 1.564 | mm | ← | | 0.764 | mm | ← | |
| | Material | | ε′r = 4.5 | | ← | | ε′r = 2.6 | | ← | |
| | properties | | tan | | | | tan | | | |
| | | | δ = 0.014 | | | | δ = 0.0025 | | | |
| Dielectric | Material | | Copper | | ← | | Copper | | ← | |
| | Thickness | | 0.018 | mm | ← | | 0.018 | mm | ← | |
| | Material | | σ = 5.8x | | ← | | σ = 5.8x | | ← | |
| | properties | | 10\hat{ }7 S/m | | | | 10\hat{ }7 S/m | | | |
| Unit cell 1 | l1 | | 15.000 | mm | 14.750 | mm | 3.250 | mm | 3.390 | mm |
| (without | | | | | | | | | | |
| dimensional | w1 | | 8.306 | mm | 9.000 | mm | 1.582 | mm | 1.000 | mm |
| error) | | | | | | | | | | |
| Unit cell 2 | l2 | | 15.000 | mm | 11.412 | mm | 3.250 | mm | 3.709 | mm |
| (without | | | | | | | | | | |
| dimensional | w2 | | 1.305 | mm | 9.000 | mm | 2.955 | mm | 1.000 | mm |
| error) | | | | | | | | | | |
| Unit cell 3 | l3 | | 15.000 | mm | 15.237 | mm | 3.250 | mm | 3.067 | mm |
| (without | | | | | | | | | | |
| dimensional | w3 | | 9.608 | mm | 9.000 | mm | 0.319 | mm | 1.000 | mm |
| error) | | | | | | | | | | |
| Unit cell 4 | l4 | | | | | | | | | |
| (without | | | | | | | | | | |
| dimensional | w4 | | | | | | | | | |
| error) | | | | | | | | | | |

| Number of unit cells | | 12 × 12 | | ← | 9 × 9 | | ← |
|---|---|---|---|---|---|---|---|
| constituting reflector | | | | | | | |
| Size of reflector | | 285.504 | mm square | ← | 60.714 | mm square | ← |
| RCS | Without | 7.03 | | 7.06 | 0.26 | | 0.22 |
| (dBsm) at | dimensional | | | | | | |
| θrx | error | | | | | | |
| | With | 7.02 | | 6.87 | 0.18 | | −0.71 |
| | dimensional | | | | | | |
| | error | | | | | | |

| Change of RCS due to | −0.02 | −0.18 | −0.08 | −0.94 |
|---|---|---|---|---|
| dimensional error (dBsm) | | | | |

| | Comp. | | | | Comp. | | | |
|---|---|---|---|---|---|---|---|---|
| | Ex. 3 | | Ex. 4. | | Ex. 4 | | | |
| Operating | | | 100 | GHz | | | | |
| frequency | | | | | | | | |
| Design | Element | | Element | | Element | | | |
| parameter | length l | | width w | | length l | | | |
| Design | ← | | 0°45° | | ← | | | |
| angle | | | | | | | | |
| (θixθrx) | | | | | | | | |
| Size Lx of | ← | | 4.240 | mm | ← | | | |
| reflection | | | | | | | | |
| control | | | | | | | | |
| area | | | | | | | | |
| Number of | ← | | 4 | | ← | | | |
| divisions n | | | | | | | | |
| of | | | | | | | | |
| reflection | | | | | | | | |
| control | | | | | | | | |
| area | | | | | | | | |
| Size of | ← | | 1.060 | mm | ← | | | |
| unit cell | | | | | | | | |
| Element | Copper | | ← | | Copper | | ← | |
| | 0.018 | mm | ← | | 0.002 | mm | | |
| | σ = 5.8x | | ← | | σ = 5.8x | | ← | |
| | 10\hat{ }7 S/m | | | | 10\hat{ }7 S/m | | | |
| Dielectric | PTFE | | ← | | PET | | ← | |
| | 0.200 | mm | ← | | 0.050 | mm | ← | |
| | ε′r = 2.06 | | ← | | ε’r = 3.03 | | ← | |
| | tan | | | | tan | | | |
| | δ = 0.0007 | | | | δ = 0.0047 | | | |
| Dielectric | Copper | | ← | | Copper | | ← | |
| | 0.018 | mm | ← | | 0.002 | mm | ← | |
| | σ = 5.8x | | ← | | σ = 5.8x | | ← | |
| | 10\hat{ }7 S/m | | | | 10\hat{ }7 S/m | | | |
| Unit cell 1 | 1.700 | mm | 1.844 | mm | 0.900 | mm | 0.929 | mm |
| (without | | | | | | | | |
| dimensional | 1.362 | mm | 0.500 | mm | 0.532 | mm | 0.400 | mm |
| error) | | | | | | | | |
| Unit cell 2 | 1.700 | mm | 1.581 | mm | 0.900 | mm | 0.959 | mm |
| (without | | | | | | | | |
| dimensional | 0.142 | mm | 0.500 | mm | 0.656 | mm | 0.400 | mm |
| error) | | | | | | | | |
| Unit cell 3 | 1.700 | mm | 1.753 | mm | 0.900 | mm | 0.862 | mm |
| (without | | | | | | | | |
| dimensional | 0.857 | mm | 0.500 | mm | 0.173 | mm | 0.400 | mm |
| error) | | | | | | | | |
| Unit cell 4 | | | | | 0.900 | mm | 0.910 | mm |
| (without | | | | | | | | |
| dimensional | | | | | 0.456 | mm | 0.400 | mm |
| error) | | | | | | | | |
| Number of unit cells | 27 × 27 | | ← | | 12 × 12 | | ← | |
| constituting reflector | | | | | | | | |
| Size of reflector | 63.585 | mm square | ← | | 12.720 | mm square | ← | |
| RCS | 7.46 | | 7.40 | | −17.4 | | −17.5 | |
| (dBsm) at | | | | | | | | |
| θrx | 7.46 | | 5.12 | | −19.9 | | −29.9 | |
| Change of RCS due to | 0.00 | | −2.28 | | −2.51 | | −12.34 | |
| dimensional error (dBsm) | | | | | | | | |

TABLE 2

| | | Ex. 5 | | Ex. 6 | | Ex. 7 | |
|---|---|---|---|---|---|---|---|
| Operating frequency | | 27.2 | GHz | 27.2 | GHz | 28 | GHz |
| Design parameter | | Element width w | | Element width w | | Element width w | |
| Design angle (θix/θrx) | | 33°/0° | | 33°/0° | | 0°45° | |
| Size Lx of reflection control area | | 20.238 | mm | 20.238 | mm | 15.140 | mm |
| Number of divisions n of reflection | | 3 | | 3 | | 4 | |
| control area | | | | | | | |
| Size of unit cell | | 6.746 | mm | 6.746 | mm | 3.785 | mm |
| Design | Materia. | PBT/PP | | Polyimide | | | |
| layer/Protective | Thickness | 0.098 | mm | 0.060 | mm | | |
| layer | Material | ε′r = 2.70 | | ε′r = 3.23 | | | |
| | properties | tan δ = 0.0060 | | tan δ = 0.0144 | | | |
| Element | Material | Copper | | Copper | | Copper | |
| | Thickness | 0.018 | mm | 0.018 | mm | 0.002 | mm |
| | Material | σ = 5.8x | | σ = 5.8x | | σ = 5.8x | |
| | properties | 10\hat{ }7 S/m | | 10\hat{ }7 S/m | | 10\hat{ }7 S/m | |
| Dielectric | Material | Glass/fluororesin | | Glass/fluororesin | | PS | |
| | Thickness | 0.764 | mm | 0.764 | mm | 0.050 | mm |
| | Material | ε′r = 2.6 | | ε′r = 2.6 | | ε′r = 2.47 | |
| | properties | tan δ = 0.0025 | | tan δ = 0.0025 | | tan δ = 0.00064 | |
| Dielectric | Material | Copper | | Copper | | Copper | |
| | Thickness | 0.018 | mm | 0.018 | mm | 0.002 | mm |
| | Material | σ = 5.8x | | σ = 5.8x | | σ = 5.8x | |
| | properties | 10\hat{ }7 S/m | | 10\hat{ }7 S/m | | 10\hat{ }7 S/m | |
| Unit cell 1 | l1 | 3.250 | mm | 3.000 | mm | 3.450 | mm |
| (without | w1 | 1.582 | mm | 1.703 | mm | 2.697 | mm |
| dimensional error) | | | | | | | |
| Unit cell 2 | l2 | 3.250 | mm | 3.000 | mm | 3.450 | mm |
| (without | w2 | 2.955 | mm | 2.986 | mm | 2.892 | mm |
| dimensional error) | | | | | | | |
| Unit cell 3 | l3 | 3.250 | mm | 3.000 | mm | 3.450 | mm |
| (without | w3 | 0.319 | mm | 0.075 | mm | 2.460 | mm |
| dimensional error) | | | | | | | |
| Unit cell 4 | l4 | | | | | 3.450 | mm |
| (without | w4 | | | | | 2.636 | mm |
| dimensional error) | | | | | | | |

| Number of unit cells constituting | 9 × 9 | 9 × 9 | 16 × 16 |
|---|---|---|---|
| reflector | | | |

| Size of reflector | 60.714 mm | 60.714 mm | 60.560 mm |
|---|---|---|---|
| | square | square | square |
| RCS (dBsm) at θrx | 0.23 | 0.17 | −5.91 |

### Comparative Example 1

A reflectarray 6 having the basic structure was prepared in which copper with a thickness of 0.018 mm was used for the layer of element patterns 1 and the ground 3, and a composite material of glass/epoxy resin with a thickness of 1.564 mm was used for the dielectric layer 2. The electrical conductivity of the copper was 5.8×10\hat{ }7 Siemens/m, the real part of the dielectric constant of the dielectric layer 2 was 4.5, and tan δ was 0.014.

The operating frequency was 4.85 GHz, the target reflection characteristics were set to θix=−60°, θrx=0°, and θiy=θry=0°, and the size Lx of the reflection control area 5 in the x axis direction was determined to be 71.376 mm using Formula (1).

The number of divisions of the reflection control area 5 was 3, and the size of the unit cell in the x axis direction and the y axis direction was 23.792 mm. The shape of each element pattern in the xy plane was a cross-patch in which two rectangular patches were orthogonal to each other. In this example, only the element length was different between the element patterns in the reflection control area 5. Specifically, the element lengths were set as lx1=ly1, lx2=ly2 and lx3=ly3, and the element width was wx1=wx2=wx3=wy1=wy2=wy3=9.000 mm.

In Tables 1 and 2 and in the drawings and the text in the following explanation, the unit cells included in the reflection control area 5 are represented as unit cell 1, unit cell 2, . . . unit cell p (p is an integer greater than or equal to 1 and smaller than or equal to the number of divisions n), and in the unit cell p, the element length in the x axis direction is lxp, the element length in the y axis direction is lyp, the element width in the x axis direction is wxp, and the element width in the y axis direction is wyp. However, when lxp and lyp are equal, the subscripts x and y may be omitted, when wxp and wyp are equal, the subscripts x and y may be omitted, and when the unit cell is not specified, the subscript p may be omitted.

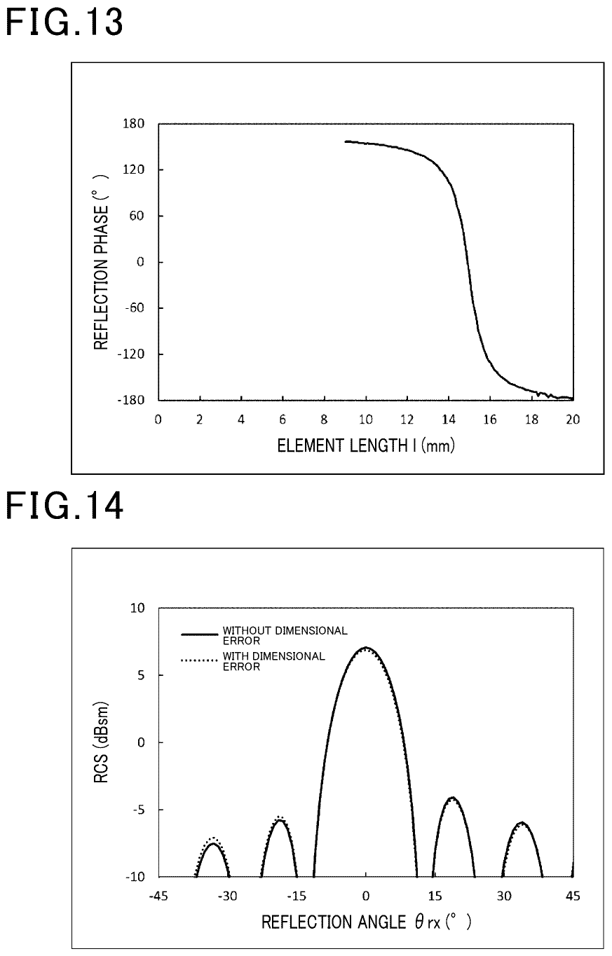

First, the reflection phases of the unit cells with respect to the element lengths 1 were analyzed using finite element analysis software (HFSS) manufactured by Ansys. FIG. 13 is a graph showing an analysis of unit cells in a design process, i.e., showing reflection phases in which the element width of the element patterns is set to wx=wy=9.000 mm with the element length I changed, according to Comparative Example 1. As the element length l changed, the reflection phase changed. In FIG. 13, the element length l on the horizontal axis indicates the element length lx in the x axis direction and the element length ly in the y axis direction. In the following description also, the graphs of the element length l and the reflection phase will be shown under the same conditions as in FIG. 13.

Next, based on the analysis of the unit cells, the element lengths l of the unit cells were determined so as to conform to the impedance distribution of Formula (7). The element lengths l were set to lx1=ly1=14.750 mm, lx2=ly2=11.412 mm, and lx3=ly3=15.237 mm. The element length l of each element pattern determined was assumed to have no dimensional error.

The reflectarray 6 had 12×12 unit cells arranged in the x and y axis directions, and its size in the xy plane was 285.504 mm square. The reflection characteristics when the reflectarray 6 was irradiated with polarized waves at θix=−60° and θiy=0° parallel to the y axis were analyzed using HFSS.

In order to understand the effect of dimensional errors on the reflection characteristics, dimensional errors due to cutting were assumed and a similar analysis was performed for the case where the element length l of each element pattern of the reflectarray 6 was increased by 0.100 mm.

FIG. 14 is a graph showing an analysis of the reflectarray 6, i.e., showing reflection characteristics of the reflectarray 6 with and without a dimensional error in the xz plane, according to Comparative Example 1. In FIG. 14, the horizontal axis indicates reflection angle θrx, and the vertical axis indicates radar reflection cross section (RCS). The RCS is a value that substantially corresponds to the intensity of the reflected waves. In the reflectarray 6 without any dimensional error, the electromagnetic waves incident at θix=−60° were reflected in the desired direction of θrx=0°, and the RCS was 7.06 dBsm. On the other hand, in the reflectarray 6 with a dimensional error, although reflection occurred in the direction of θrx=0°, the RCS was 6.87 dBsm, and the change in RCS due to the dimensional error was −0.18 dBsm.

### Example 1

A reflectarray similar to that of Comparative Example 1 except for the element pattern shape was prepared. Regarding the element pattern shape, only the element width was different between the element patterns in the reflection control area 5. Specifically, the element length of the element patterns was lx1=lx2=lx3=ly1=ly2=ly3=15.000 mm and the element widths thereof were set as wx1=wy1, wx2=wy2 and wx3=wy3. The reflection phases of the unit cells with respect to the element width w and the reflection characteristics of the reflectarray 6 with and without a dimensional error were analyzed using HFSS.

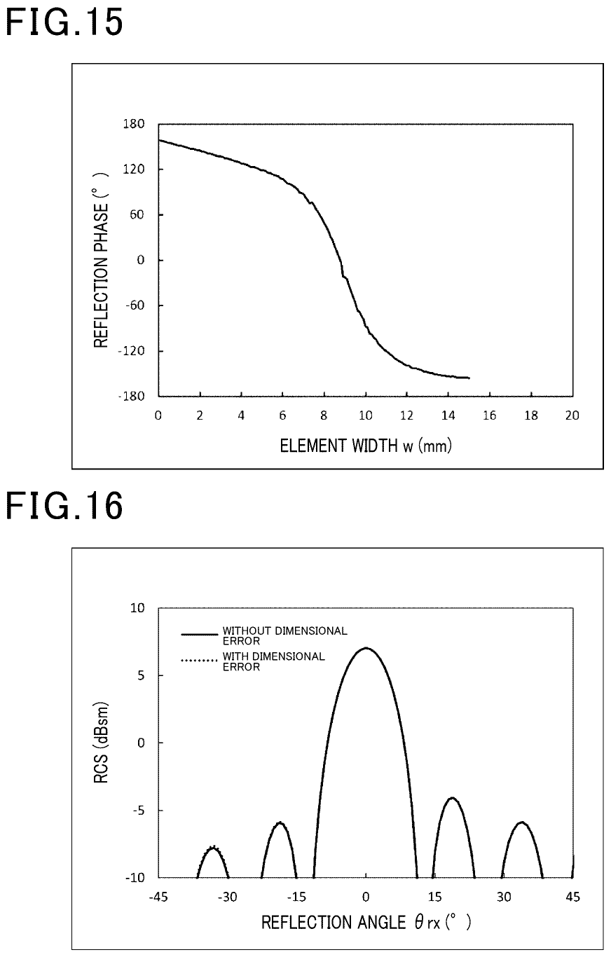

FIG. 15 is a graph showing an analysis of unit cells in a design process, i.e., showing reflection phases in which the element length of the element patterns is set to lx=ly=15.000 mm with the element width w changed, according to Example 1. In FIG. 15, the element width w on the horizontal axis indicates the element width wx in the x axis direction and the element width wy in the y axis direction. In the following description also, the graphs of the element width w and the reflection phase will be shown under the same conditions as in FIG. 15. As the element width changed, the reflection phase changed. Also, the slope of the reflection phase with respect to the element width was gentler than that in Comparative Example 1 shown in FIG. 13 in which the element length was changed. For example, in order to change the reflection phase from 120° to −120°, in Comparative Example 1, the element length l needs to be changed by 2.5 mm from approximately 13.5 mm to 16 mm, whereas in Example 1, the element width w needs to be changed by 6 mm from approximately 5 mm to 11 mm. This means that when a dimensional error of the same order occurs, the present invention, which uses the element width as design parameters, has a smaller range of change in reflection phase in the unit cells, and as a result, the change in reflection characteristics of the reflectarray 6 is smaller.

The element widths w were determined to be wx1=wy1=8.306 mm, wx2=wy2=1.305 mm, and wx3=wy3=9.608 mm, respectively. FIG. 16 is a graph showing an analysis of the reflectarray 6, i.e., showing reflection patterns of the reflectarray 6 with and without a dimensional error in the xz plane, according to Example 1. In the reflectarray 6 without a dimensional error, the electromagnetic waves incident at θix=−60° were reflected in the desired direction of θrx=0°, and the RCS was 7.03 dBsm. Furthermore, even in the reflectarray 6 with a dimensional error, reflection in the direction of θrx=0° occurred, and the RCS was 7.02 dBsm. Therefore, the change in RCS due to the dimensional error was −0.02 dBsm, and compared to the reflectarray 6 of Comparative Example 1 in which the element length was used as design parameters, decrease in reflection intensity due to the dimensional error was suppressed.

The design method will be specifically described. A description will be given of a method of designing a reflectarray in which multiple identical reflection control areas are arranged in the x and y axis directions.

(Step 1) First, target reflection characteristics (operating frequency, incidence angle, and reflection angle) are set.

(Step 2) Next, the sizes Lx and Ly of each reflection control area are determined using Formulas (1) and (2). When asymmetrical reflection is designed to occur only in the x axis direction, Lx is determined using Formula (1), and Ly is set to an arbitrary size. When asymmetrical reflection is designed to occur only in the y axis direction, Ly is determined using Formula (2), and Lx is set to an arbitrary size.

(Step 3) Next, the size Lx of the reflection control area is divided into n, and Ly is divided into m. The size of the unit cell is determined.

(Step 4) Next, element lengths lx and ly of an element pattern are determined in the range that can be fit to the unit cell. Since the element patterns are arranged unbiased and evenly in the respective unit cells, the gaps gx and gy between the element patterns are determined accordingly.

(Step 5) Next, the reflection phases of the unit cells are analyzed using the element widths w as design parameters. As shown in FIG. 15, the reflection phase is derived using the element widths wx and wy of the element patterns as design parameters, and an analysis showing the relationship between element width and reflection phase in the unit cells is obtained.

(Step 6) Next, an ideal reflection phase or impedance for realizing the target reflection characteristics of a reflection control area is calculated using Formulas (3) to (8), and element widths w for realizing the desired reflection phase or impedance are selected based on the above analysis. In Example 1, three element widths are selected, and a reflection control area including three unit cells is set.

(Step 7) Next, a reflectarray is formed so as to include at least one reflection control area. The reflection characteristics of the reflectarray are analyzed.

(Step 8) It should be noted that, based on the analysis of step 7, the element widths wx and wy can be finely adjusted further using an optimization method so as to further increase the RCS at the target reflection angle and to reduce the RCS at angles other than the target angle.

### Comparative Example 2

A reflectarray 6 having the basic structure was prepared in which copper with a thickness of 0.018 mm was used for the layer of element patterns 1 and the ground 3, and a composite material of glass/fluororesin with a thickness of 0.764 mm was used for the dielectric layer 2. The electrical conductivity of the copper was 5.8×10\hat{ }7 Siemens/m, the real part of the dielectric constant of the dielectric layer 2 was 2.6, and tan δ was 0.0025.

The operating frequency was 27.2 GHz, the target reflection characteristics were set to θix=−33°, θrx=0°, and θiy=θry=0°, and the size Lx of the reflection control area 5 in the x axis direction was determined to be 20.238 mm using Formula (1).

The number of divisions of reflection control area 5 was 3, and the size of the unit cell in the x and y axis directions was 6.746 mm. The shape of each element pattern in the xy plane was a cross-patch in which two rectangular patches were orthogonal to each other. In this example, only the element length was different between the element patterns in the reflection control area 5. Specifically, the element lengths were set as lx1=ly1, lx2=ly2 and lx3=ly3, and the element width was wx1=wx2=wx3=wy1=wy2=wy3=1.000 mm.

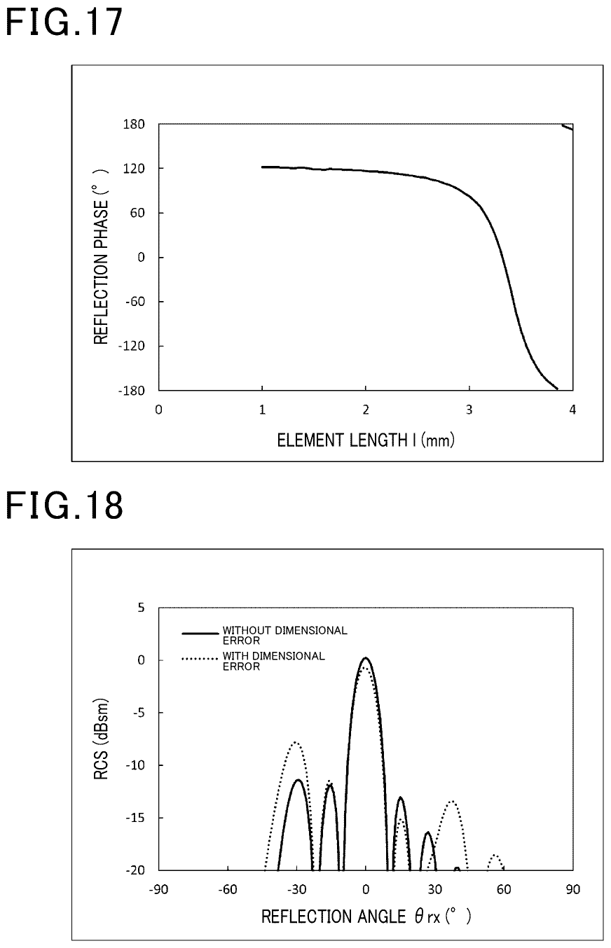

First, the reflection phases of the unit cells with respect to the element lengths 1 were analyzed using HFSS. FIG. 17 is a graph showing an analysis of unit cells in a design process, i.e., showing reflection phases in which the element width of the element patterns is set to wx=wy=1.000 mm with the element length I changed, according to Comparative Example 2. As the element length l changed, the reflection phase changed.

Next, based on the analysis of the unit cells, the element lengths l of the unit cells were determined so as to conform to the impedance distribution of Formula (7). The element lengths l were set to lx1=ly1=3.390 mm, lx2=ly2=3.709 mm, and lx3=ly3=3.067 mm. The element length l of each element pattern determined was assumed to have no dimensional error.

The reflectarray 6 had 9×9 unit cells arranged in the x and y axis directions, and its size in the xy plane was 60.714 mm square. The reflection characteristics when the reflectarray 6 was irradiated with polarized waves at θix=33° and θiy=0° parallel to the y axis were analyzed using HFSS.

In order to understand the effect of dimensional errors on the reflection characteristics, dimensional errors due to cutting were assumed and a similar analysis was performed for the case where the element length l of each element pattern of the reflectarray 6 was increased by 0.100 mm.

FIG. 18 is a graph showing an analysis of the reflectarray 6, i.e., showing reflection characteristics of the reflectarray 6 with and without a dimensional error in the xz plane, according to Comparative Example 2. In the reflectarray 6 without a dimensional error, the electromagnetic waves incident at θix=33° were reflected in the desired direction of θrx=0°, and the RCS was 0.22 dBsm. On the other hand, in the reflectarray 6 with a dimensional error, although reflection occurred in the direction of θrx=0°, the RCS was −0.71 dBsm, and the change in RCS due to the dimensional error was −0.94 dBsm.

### Example 2

A reflectarray similar to that of Comparative Example 2 except for the element pattern shape was prepared. Regarding the element pattern shape, only the element width was different between the element patterns in the reflection control area 5. Specifically, the element length of the element patterns was lx1=lx2=lx3=ly1=ly2=ly3=3.250 mm and the element widths thereof were set as wx1=wy1, wx2=wy2 and wx3=wy3. The reflection phases of the unit cells relative to the element widths w and the reflection characteristics of the reflectarray with and without a dimensional error were analyzed using HFSS.

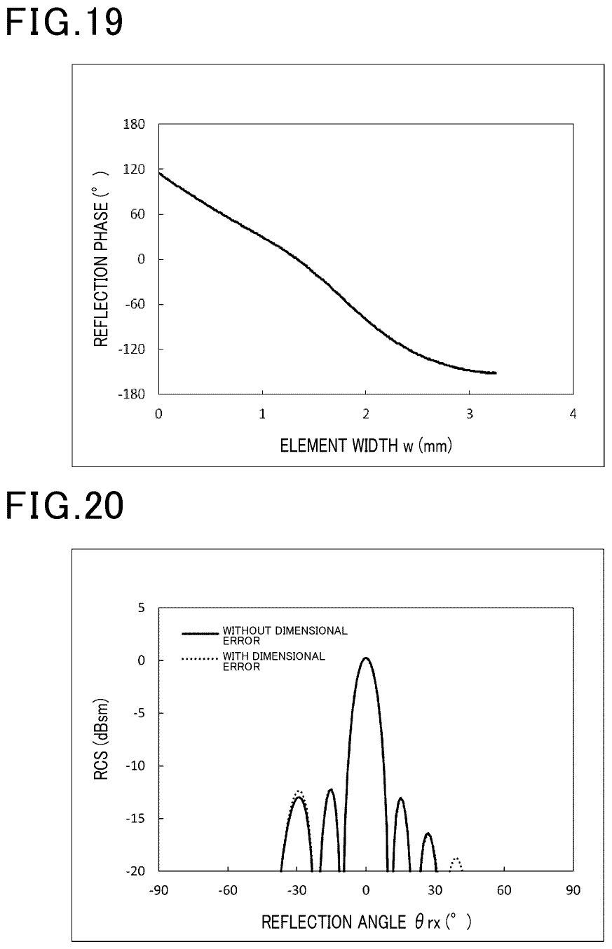

FIG. 19 is a graph showing an analysis of unit cells in a design process, i.e., showing reflection phases in which the element length of the element patterns is set to lx=ly=3.250 mm with the element width w changed, according to Example 2. As the element width changed, the reflection phase changed. Also, the slope of the reflection phase with respect to the element width was gentler than that in Comparative Example 2 shown in FIG. 17 in which the element length was changed. For example, in order to change the reflection phase from 60° to −120°, in Comparative Example 2, the element length l needs to be changed by 0.3 mm from approximately 3.2 mm to 3.5 mm, whereas in Example 2, the element width w needs to be changed by 1.8 mm from approximately 0.6 mm to 2.4 mm. This means that when a dimensional error of the same order occurs, Example 2, which uses the element width as design parameters, has a smaller range of change in reflection phase in the unit cells, and as a result, the change in the reflection characteristics of the reflectarray 6 is smaller.

The element widths w were determined to be wx1=wy1=1.582 mm, wx2=wy2=2.955 mm, and wx3=wy3=0.319 mm, respectively. FIG. 20 is a graph showing an analysis of the reflectarray 6, i.e., showing reflection patterns of the reflectarray 6 with and without a dimensional error in the xz plane, according to Example 2. In the reflectarray 6 without a dimensional error, the electromagnetic waves incident at θix=33° were reflected in the desired direction of θrx=0°, and the RCS was 0.26 dBsm. Furthermore, even in the reflectarray 6 with a dimensional error, reflection in the direction of θrx=0° occurred, and the RCS was 0.18 dBsm. Therefore, the change in RCS due to the dimensional error was −0.08 dBsm, and compared to the reflectarray 6 of Comparative Example 2 in which the element length was used as design parameters, decrease in reflection intensity due to the dimensional error was suppressed.

### Comparative Example 3

A reflectarray 6 having the basic structure was prepared in which copper with a thickness of 0.018 mm was used for the layer of element patterns 1 and the ground 3, and PTFE with a thickness of 0.200 mm was used for the dielectric layer 2. The electrical conductivity of the copper was 5.8×10\hat{ }7 Siemens/m, the real part of the dielectric constant of the dielectric layer 2 was 2.06, and tan δ was 0.0007.

The operating frequency was 60 GHz, the target reflection characteristics were set to θix=−0°, θrx=45°, and θiy=θry=0°, and the size Lx of the reflection control area 5 in the x axis direction was determined to be 7.065 mm using Formula (1).

The number of divisions of the reflection control area 5 was 3, and the size of the unit cell in the x and y axis directions was 2.355 mm. The shape of each element pattern in the xy plane was a cross-patch in which two rectangular patches were orthogonal to each other. In this example, only the element length was different between the element patterns in the reflection control area 5. Specifically, the element lengths were set as lx1=ly1, lx2=ly2 and lx3=ly3, and the element width was wx1=wx2=wx3=wy1=wy2=wy3=0.500 mm.

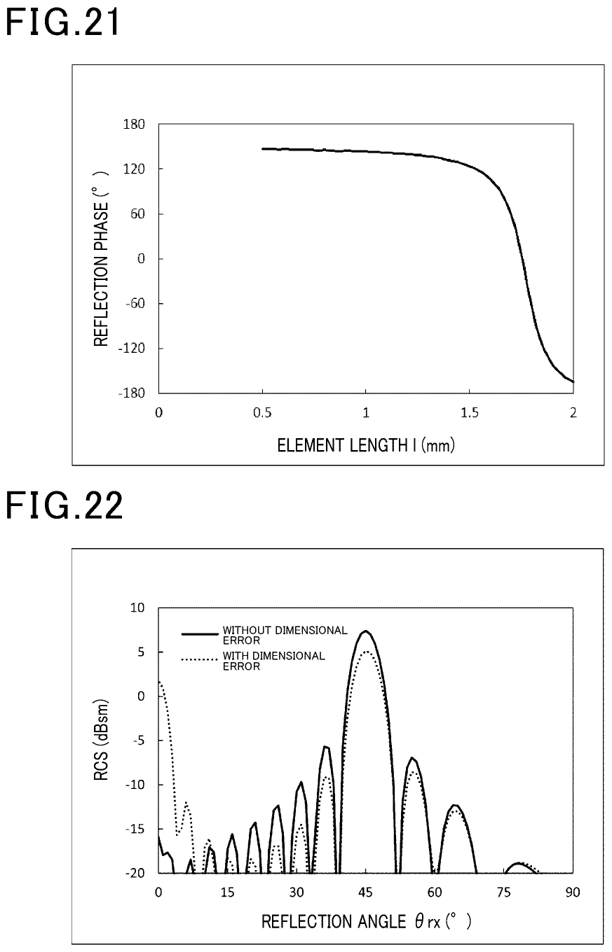

First, the reflection phases of the unit cells with respect to the element lengths 1 were analyzed using HFSS. FIG. 21 is a graph showing an analysis of unit cells in a design process, i.e., showing reflection phases in which the element width of the element patterns is set to wx=wy=0.500 mm with the element length I changed, according to Comparative Example 3. As the element length l changed, the reflection phase changed.

Next, based on the analysis of the unit cells, the element lengths l of the unit cells were determined so as to conform to the impedance distribution of Formula (7). The element lengths l were set to lx1=ly1=1.844 mm, lx2=ly2=1.581 mm, and lx3=ly3=1.753 mm. The element length l of each element pattern determined was assumed to have no dimensional error.

The reflectarray 6 had 27×27 unit cells arranged in the x and y axis directions, and its size in the xy plane was 63.585 mm square. The reflection characteristics when the reflectarray 6 was irradiated with polarized waves at θix=0° and θiy=0° parallel to the y axis were analyzed using HFSS.

In order to understand the effect of dimensional errors on the reflection characteristics, dimensional errors due to cutting were assumed and a similar analysis was performed for the case where the element length l of each element pattern of the reflectarray 6 was increased by 0.100 mm.

FIG. 22 is a graph showing an analysis of the reflectarray 6, i.e., showing reflection characteristics of the reflectarray 6 with and without a dimensional error in the xz plane, according to Comparative Example 3. In the reflectarray 6 without a dimensional error, the electromagnetic waves incident at θix=0° were reflected in the desired direction of θrx=45°, and the RCS was 7.40 dBsm. On the other hand, in the reflectarray with a dimensional error, although reflection occurred in the direction of θrx=0°, the RCS was 5.12 dBsm, and the change in RCS due to the dimensional error was −2.28 dBsm.

### Example 3

A reflectarray similar to that of Comparative Example 3 except for the element pattern shape was prepared. Regarding the element pattern shape, only the element width was different between the element patterns in the reflection control area 5. Specifically, the element length of the element patterns was lx1=lx2=lx3=ly1=ly2=ly3=1.700 mm and the element widths thereof were set as wx1=wy1, wx2=wy2 and wx3=wy3. The reflection phases of the unit cells with respect to the element width w and the reflection characteristics of the reflectarray 6 with and without a dimensional error were analyzed using HFSS.

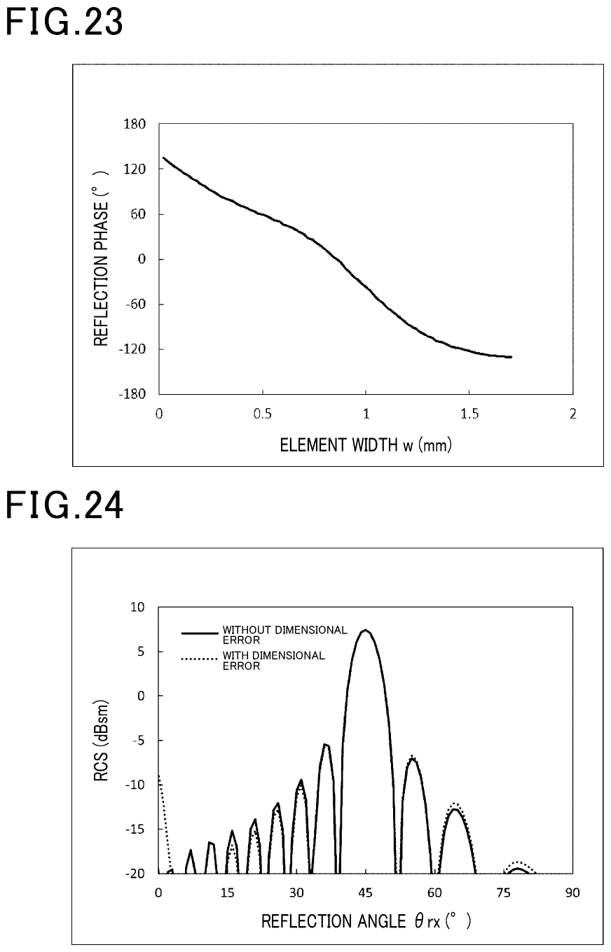

FIG. 23 is a graph showing an analysis of unit cells in a design process, i.e., showing reflection phases in which the element length of the element patterns is set to lx=ly=1.700 mm with the element width w changed, according to Example 3. As the element width changed, the reflection phase changed. Also, the slope of the reflection phase with respect to the element width was gentler than that in Comparative Example 3 shown in FIG. 21 in which the element length was changed. For example, in order to change the reflection phase from 120° to −120°, in Comparative Example 3, the element length l needs to be changed by 0.3 mm from approximately 1.5 mm to 1.8 mm, whereas in Example 3, the element width w needs to be changed by 1.4 mm from approximately 0.1 mm to 1.5 mm. This means that when a dimensional error of the same order occurs, Example 3, which uses the element width as design parameters, has a smaller range of change in reflection phase in the unit cells, and as a result, the change in the reflection characteristics of the reflectarray 6 is smaller.

The element widths w were determined to be wx1=wy1=1.362 mm, wx2=wy2=0.142 mm, and wx3=wy3=0.857 mm, respectively. FIG. 24 is a graph showing an analysis of the reflectarray 6, i.e., showing reflection patterns of the reflectarray 6 with and without a dimensional error in the xz plane, according to Example 3. In the reflectarray 6 without a dimensional error, the electromagnetic waves incident at θix=0° were reflected in the desired direction of θrx=45°, and the RCS was 7.46 dBsm. Furthermore, even in the reflectarray 6 with a dimensional error, reflection in the direction of θrx=0° occurred, and the RCS was 7.46 dBsm. Therefore, the change in RCS due to the dimensional error was 0.00 dBsm, and compared to the reflectarray 6 of Comparative Example 3 in which the element length was used as design parameters, decrease in reflection intensity due to the dimensional error was suppressed.

### Comparative Example 4

A reflectarray 6 having the basic structure was prepared in which copper with a thickness of 0.002 mm was used for the layer of element patterns 1 and the ground 3, and PET with a thickness of 0.050 mm was used for the dielectric layer 2. The electrical conductivity of the copper was 5.8×10\hat{ }7 Siemens/m, the real part of the dielectric constant of the dielectric layer 2 was 3.03, and tan δ was 0.00476.

The operating frequency was 100 GHz, the target reflection characteristics were set to θix=−0°, θrx=45°, and θiy=θry=0°, and the size Lx of the reflection control area 5 in the x axis direction was determined to be 4.240 mm using Formula (1).

The number of divisions of the reflection control area 5 was 4, and the size of the unit cell in the x and y axis directions was 1.060 mm. The shape of each element pattern in the xy plane was a cross-patch in which two rectangular patches were orthogonal to each other. In this example, only the element length was different between the element patterns in the reflection control area 5. Specifically, the element lengths were set as lx1=ly1, lx2=ly2, lx3=ly3 and lx4=ly4, and the element width was wx1=wx2=wx3=wx4=wy1=wy2=wy3=wy4=0.400 mm.

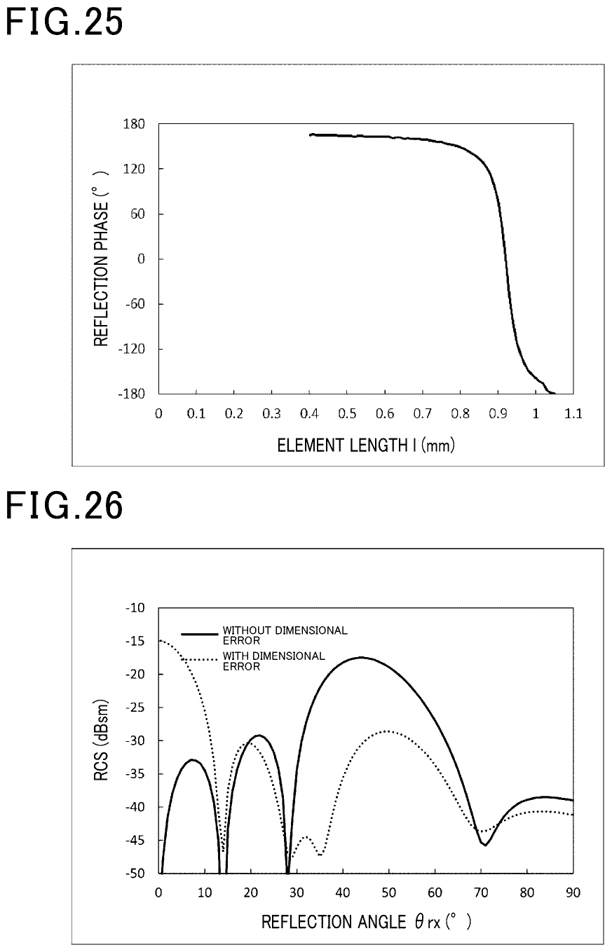

First, the reflection phases of the unit cells with respect to the element lengths 1 were analyzed using HFSS. FIG. 25 is a graph showing an analysis of unit cells in a design process, i.e., showing reflection phases in which the element width of the element patterns is set to wx=wy=0.400 mm with the element length I changed, according to Comparative Example 4. As the element length l changed, the reflection phase changed.

Next, based on the analysis of the unit cells, the element lengths l of the unit cells were determined so as to conform to the impedance distribution of Formula (7). The element lengths l were set to lx1=ly1=0.929 mm, lx2=ly2=0.959 mm, lx3=ly3=0.862 mm, and lx4=ly4=0.910 mm. The element length l of each element pattern determined was assumed to have no dimensional error.

The reflectarray 6 had 12×12 unit cells arranged in the x and y axis directions, and its size in the xy plane was 12.720 mm square. The reflection characteristics when the reflectarray 6 was irradiated with polarized waves at θix=0° and θiy=0° parallel to the y axis were analyzed using HFSS.

In order to understand the effect of dimensional errors on the reflection characteristics, dimensional errors due to cutting were assumed and a similar analysis was performed for the case where the element length l of each element pattern of the reflectarray 6 was increased by 0.100 mm.

FIG. 26 is a graph showing an analysis of the reflectarray 6, i.e., showing reflection characteristics of the reflectarray 6 with and without a dimensional error in the xz plane, according to Comparative Example 4. In the reflectarray 6 without a dimensional error, the electromagnetic waves incident at θix=0° were reflected in the desired direction of θrx=45°, and the RCS was −17.5 dBsm. On the other hand, in the reflectarray 6 with a dimensional error, although reflection occurred in the direction of θrx=0°, the RCS was −29.9 dBsm, and the change in RCS due to the dimensional error was −12.34 dBsm.

### Example 4

A reflectarray similar to that of Comparative Example 4 except for the element pattern shape was prepared. Regarding the element pattern shape, only the element width was different between the element patterns in the reflection control area 5. Specifically, the element length of the element patterns was lx1=lx2=lx3=lx4=ly1=ly2=ly3=ly4=0.900 mm and the element widths thereof were set as wx1=wy1, wx2=wy2, wx3=wy3 and wx4=wy4. The reflection phases of the unit cells with respect to the element width w and the reflection characteristics of the reflectarray 6 with and without a dimensional error were analyzed using HFSS.

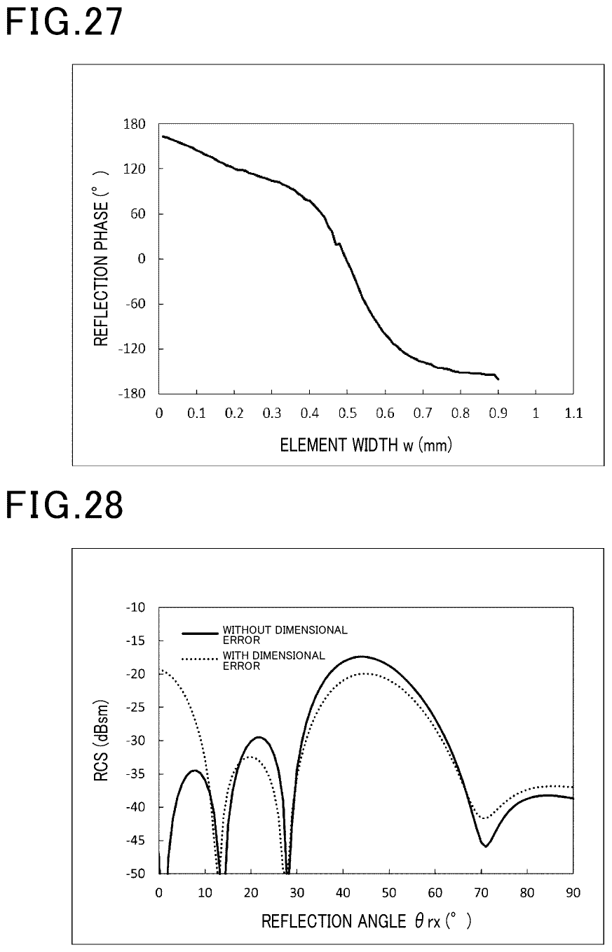

FIG. 27 is a graph showing an analysis of unit cells in a design process, i.e., showing reflection phases in which the element length of the element patterns is set to lx=ly=0.900 mm with the element width w changed, according to Example 4. As the element width changed, the reflection phase changed. Also, the slope of the reflection phase with respect to the element width was gentler than that in Comparative Example 4 shown in FIG. 25 in which the element length was changed. For example, in order to change the reflection phase from 120° to −120°, in Comparative Example 4, the element length l needs to be changed by 0.1 mm from approximately 0.85 mm to 0.95 mm, whereas in Example 4, the element width w needs to be changed by 0.45 mm from approximately 0.2 mm to 0.65 mm. This means that when a dimensional error of the same order occurs, Example 4, which uses the element width as design parameters, has a smaller range of change in reflection phase in the unit cells, and as a result, the change in the reflection characteristics of the reflectarray 6 is smaller.

The element widths w were determined to be wx1=wy1=0.532 mm, wx2=wy2=0.656 mm, wx3=wy3=0.173 mm, and wx4=wy4=0.456 mm respectively. FIG. 28 is a graph showing an analysis of the reflectarray 6, i.e., showing reflection patterns of the reflectarray 6 with and without a dimensional error in the xz plane, according to Example 4. In the reflectarray 6 without a dimensional error, the electromagnetic waves incident at θix=0° were reflected in the desired direction of θrx=45°, and the RCS was −17.4 dBsm. Furthermore, even in the reflectarray with a dimensional error, reflection in the direction of θrx=0° occurred, and the RCS was −19.9 dBsm. Therefore, the change in RCS due to the dimensional error was −2.51 dBsm, and compared to the reflectarray of Comparative Example 4 in which the element length was used as design parameters, decrease in reflection intensity due to the dimensional error was suppressed.

### Example 5

The basic structure was prepared in which copper with a thickness of 0.018 mm was used for the layer of element patterns 1 and the ground 3, and a composite material of glass/fluororesin with a thickness of 0.764 mm was used for the dielectric layer 2. Then, a design layer 10 having a thickness of 0.098 mm was laminated on the element pattern side of the basic structure via a gap of 0.500 mm using the method shown in FIG. 2C to prepare a reflectarray 6c. The electrical conductivity of the copper was 5.8×10\hat{ }7 Siemens/m, the real part of the dielectric constant of the dielectric layer 2 was 2.6 and tan δ was 0.0025, and the real part of the dielectric constant of the design layer 10 was 2.70 and tan δ was 0.0060.

The operating frequency was 27.2 GHz, the target reflection characteristics were set to θix=−33°, θrx=0°, and θiy=θry=0°, and the size Lx of the reflection control area 5 in the x axis direction was determined to be 20.238 mm using Formula (1).

The number of divisions of the reflection control area 5 was 3, and the size of the unit cell in the x and y axis directions was 6.746 mm. The shape of each element pattern in the xy plane was a cross-patch in which two rectangular patches were orthogonal to each other. In this example, only the element width was different between the element patterns in the reflection control area 5. Specifically, the element length was lx1=lx2=lx3=ly1=ly2=ly3=3.250 mm and the element widths were set as wx1=wy1=1.582 mm, wx2=wy2=2.955 mm, and wx3=wy3=0.319 mm.

The reflectarray 6c had 9×9 unit cells arranged in the x and y axis directions, and its size in the xy plane was 60.714 mm square. The reflection characteristics when the reflectarray 6c was irradiated with polarized waves at θix=33° and θiy=0° parallel to the y axis were analyzed using HFSS.

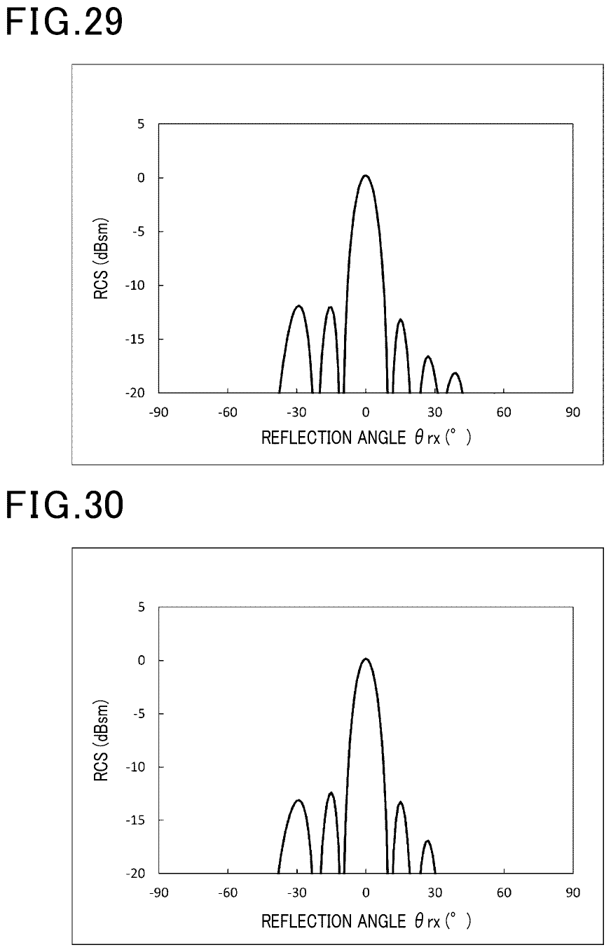

FIG. 29 is a graph showing an analysis of the reflectarray 6c, i.e., showing reflection characteristics of the reflectarray 6c in the xz plane, according to Example 5. The electromagnetic waves incident at θix=33° were reflected in the desired direction of θrx=0°, and the RCS was 0.23 dBsm.

### Example 6

The basic structure was prepared in which copper with a thickness of 0.018 mm was used for the layer of element patterns 1 and the ground 3, and a composite material of glass/fluororesin with a thickness of 0.764 mm was used for the dielectric layer 2. Then, a protective layer 8 having a thickness of 0.060 mm was laminated on the basic structure using the method shown in FIG. 2A to prepare a reflectarray 6a. The electrical conductivity of the copper was 5.8×10\hat{ }7 Siemens/m, the real part of the dielectric constant of the dielectric layer 2 was 2.6 and tan δ was 0.0025, and the real part of the dielectric constant of the protective layer 8 was 3.23 and tan δ was 0.0144.

The operating frequency was 27.2 GHz, the target reflection characteristics were set to θix=−33°, θrx=0°, and θiy=θry=0°, and the size Lx of the reflection control area 5 in the x axis direction was determined to be 20.238 mm using Formula (1).

The number of divisions of the reflection control area 5 was 3, and the size of the unit cell in the x and y axis directions was 6.746 mm. The shape of each element pattern in the xy plane was a cross-patch in which two rectangular patches were orthogonal to each other. In this example, only the element width was different between the element patterns in the reflection control area 5. Specifically, the element length was lx1=lx2=lx3=ly1=ly2=ly3=3.000 mm and the element widths were set as wx1=wy1=1.703 mm, wx2=wy2=2.986 mm, and wx3=wy3=0.075 mm.

The reflectarray 6a had 9×9 unit cells arranged in the x and y axis directions, and its size in the xy plane was 60.714 mm square. The reflection characteristics when the reflectarray was irradiated with polarized waves at θix=33° and θiy=0° parallel to the y axis were analyzed using HFSS.

FIG. 30 is a graph showing an analysis of the reflectarray 6a, i.e., showing reflection characteristics of the reflectarray 6a in the xz plane, according to Example 6. The electromagnetic waves incident at θix=33° were reflected in the desired direction of θrx=0°, and the RCS was 0.17 dBsm.

### Example 7

A reflectarray 6 having the basic structure was prepared in which copper with a thickness of 0.002 mm was used for the layer of element patterns and the ground layer, and polystyrene with a thickness of 0.050 mm was used for the dielectric layer. The electrical conductivity of the copper was 5.8×10\hat{ }7 Siemens/m, the real part of the dielectric constant of the dielectric layer was 2.47, and tan δ was 0.000644.

The operating frequency was 28 GHz, the target reflection characteristics were set to θix=−0°, θrx=45°, and θiy=θry=0°, and the size Lx of the reflection control area 5 in the x axis direction was determined to be 15.140 mm using Formula (1).

The number of divisions of the reflection control area 5 was 4, and the size of the unit cell in the x and y axis directions was 3.785 mm. The shape of each element pattern in the xy plane was a cross-patch in which two rectangular patches were orthogonal to each other. In this example, only the element width was different between the element patterns in the reflection control area 5. Specifically, the element length was lx1=lx2=lx3=lx4=ly1=ly2=ly3=ly4=3.450 mm and the element widths were set as wx1=wy1=2.697 mm, wx2=wy2=2.892 mm, wx3=wy3=2.460 mm, and wx4=wy4=2.639 mm.

The reflectarray 6 had 16×16 unit cells arranged in the x and y axis directions, and its size in the xy plane was 60.560 mm square. The reflection characteristics when the reflectarray 6 was irradiated with polarized waves at θix=0° and θiy=0° parallel to the y axis were analyzed using HFSS.

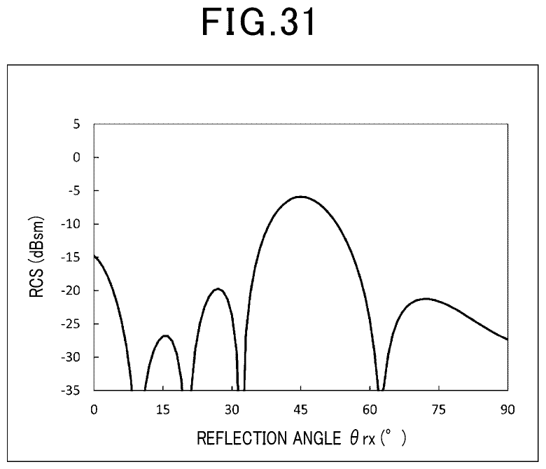

FIG. 31 is a graph showing an analysis of the reflectarray 6, i.e., showing reflection characteristics of the reflectarray 6 in the xz plane, according to Example 7. The electromagnetic waves incident at θix=0° were reflected in the desired direction of θrx=45°, and the RCS was −5.91 dBsm.

### Functions and Effects

Using the element width as design parameters, phase change based on the design parameters can be reduced, and deterioration in reflection characteristics due to dimensional errors can be suppressed. As a result, non-defective product rate can be improved for reflectarrays.

Some embodiments of the present invention have been described so far, but the present invention should not be construed as being limited to these embodiments but can be modified in various ways within the range not departing from the spirit of the present invention.

### OTHER EMBODIMENTS

The following are some possible embodiments of the present invention, but the present invention should not be limited to these.

### (Mode 1)

A reflectarray at least including a layer of element patterns, a dielectric layer, and a ground layer laminated in this order, wherein
the reflectarray includes at least one reflection control area;
the reflection control area includes at least two unit cells;
one element pattern is arranged on each unit cell;
the element pattern includes a cross-patch in which two rectangular patches are orthogonal to each other in the xy plane; and
in the reflection control area, a first element width wx which is a width of the element pattern in the x axis direction or/and a second element width wy which is a width of the element pattern in the y axis direction is/are different between the element patterns arranged in the respective at least two unit cells.

### (Mode 2)

The reflectarray according to Mode 1, wherein, in the element pattern, the two rectangular patches of the cross-patch are mutually orthogonal with a common center of gravity, and the shape of the element pattern in the xy plane is symmetric about the x axis and the y axis.

### (Mode 3)

The reflectarray according to Mode 1 or 2, wherein the center of gravity of the element pattern matches the center of gravity of the unit cell in the xy plane.

### (Mode 4)

The reflectarray according to any one of Modes 1 to 3, wherein the gaps gx between the element patterns in the x axis direction are equal to each other.

### (Mode 5)

The reflectarray according to any one of Modes 1 to 4, wherein the gaps gy between the element patterns in the y axis direction are equal to each other.

### (Mode 6)

The reflectarray according to any one of Modes 1 to 5, wherein the gaps gx between the element patterns in the x axis direction are equal to each other, the gaps gy between the element patterns in the y axis direction are equal to each other, and gx is equal to gy.

### (Mode 7)

The reflectarray according to any one of Modes 1 to 6, wherein the gaps gx between the element patterns in the x axis direction are equal to each other, the gaps gy between the element patterns in the y axis direction are equal to each other, and gx is different from gy.

### (Mode 8)

The reflectarray according to any one of Modes 1 to 7, wherein the element pattern is constituted of a cross-patch.

### (Mode 9)

The reflectarray according to any one of Modes 1 to 8, wherein the element pattern is constituted of the cross-patch and a ring arranged surrounding the cross-patch in the xy plane.

### (Mode 10)

The reflectarray according to any one of Modes 1 to 9, wherein the element pattern has a shape of a Jerusalem Cross in the xy plane.

### (Mode 11)

The reflectarray according to any one of Modes 1 to 10 including a design layer.

### (Mode 12)

The reflectarray according to any one of Modes 1 to 11 including a protective layer.

### (Mode 13)

A reflectarray device including the reflectarray according to any one of Modes 1 to 12.

### (Mode 14)

A method of designing a reflectarray that includes at least a layer of element patterns, a dielectric layer, and a ground layer laminated in this order, wherein
the reflectarray includes at least one reflection control area;
the reflection control area includes at least two unit cells;
one element pattern is arranged on each unit cell;
the element pattern includes a cross-patch in which two rectangular patches are orthogonal to each other in the xy plane; and
a first element width wx which is a width of the element pattern in the x axis direction or/and a second element width wy which is a width of the element pattern in the y axis direction is/are set based on a reflection phase derived from a simulation of reflection characteristics of the element pattern, using the first element width wx and the second element width wy as design parameters.

### REFERENCE SIGNS LIST

1, 11-lₙ, 1d₁-1d₃, 1e₁-1e₃, 1a-1c, 1^{x}₁-1^{x}ₙ, 1^{y}₁-1^{y}ₙ: element pattern; 2: Dielectric layer; 3: Ground layer; 4, 4₁-4ₙ, 4a-4c, 4^{x}₁-4^{x}ₙ, 4^{y}₁-4^{y}ₙ: Unit cell; 5, 5a-5h, 5x, 5y: Reflection control area; 6, 6a-6h: Reflect array; 7: Functional layer; 8: Protective layer; 9: Adhesive layer; 10: Design layer; 11: Mounting layer

What is claimed is:

1. A reflectarray at least including element patterns, a dielectric layer, and a ground layer laminated in this order, wherein
the reflectarray includes at least one reflection control areal;
the reflection control area includes at least two unit cells;
one element pattern is arranged on each unit cell;
the element pattern includes a cross-patch in which two rectangular patches are orthogonal to each other in the xy plane; and
in the reflection control area, a first element width wx which is a width of the element pattern in the x axis direction or/and a second element width wy which is a width of the element pattern in the y axis direction is/are different between the element patterns arranged in the respective at least two unit cells.

2. A reflectarray according to claim 1, wherein, in the element pattern, the two rectangular patches of the cross-patch are mutually orthogonal with a common center of gravity, and the shape of the element pattern in the xy plane is symmetric about the x axis and the y axis.

3. The reflectarray according to claim 1, wherein the center of gravity of the element pattern matches the center of gravity of the unit cell in the xy plane.

4. The reflectarray according to claim 1, wherein the gaps gx between the element patterns in the x axis direction are equal to each other.

5. The reflectarray according to claim 1, wherein the gaps gy between the element patterns in the y axis direction are equal to each other.

6. The reflectarray according to claim 1, wherein the gaps gx between the element patterns in the x axis direction are equal to each other, the gaps gy between the element patterns in the y axis direction are equal to each other, and gx is equal to gy.

7. The reflectarray according to claim 1, wherein the gaps gx between the element patterns in the x axis direction are equal to each other, the gaps gy between the element patterns in the y axis direction are equal to each other, and gx is different from gy.

8. The reflectarray according to claim 1, wherein the element pattern is constituted of a cross-patch.

9. The reflectarray according to claim 1, wherein the element pattern is constituted of the cross-patch and a ring arranged surrounding the cross-patch in the xy plane.

10. The reflectarray according to claim 1, wherein the element pattern has a shape of a Jerusalem Cross in the xy plane.

11. The reflectarray according to claim 1 including a design layer.

12. The reflectarray according to claim 1 including a protective layer.

13. A reflectarray device including the reflectarray according to claim 1.

14. A method of designing a reflectarray that includes at least a layer of element patterns, a dielectric layer, and a ground layer laminated in this order, wherein
the reflectarray includes at least one reflection control areal;
the reflection control area includes at least two unit cells;
one element pattern is arranged on each unit cell;
the element pattern includes a cross-patch in which two rectangular patches are orthogonal to each other in an xy plane; and
a first element width wx which is a width of the element pattern in an x axis direction or/and a second element width wy which is a width of the element pattern in a y axis direction is/are set based on a reflection phase derived from a simulation of reflection characteristics of the element pattern, using the first element width wx and the second element width wy as design parameters.
